(19) United States
(12) Patent Application Publication
(10) Pub. No.: US 2026/0079277 A1
(43) Pub. Date: Mar. 19, 2026

(54) AUTOMATED SEISMIC VELOCITY INVERSION USING DEEP NEURAL NETWORKS

(71) Applicant: Yi He

(72) Inventor: Yi He

(73) Assignees: ARAMCO FAR EAST (BEIJING) BUSINESS SERVICES CO., LTD., Beijing (CN); SAUDI ARABIAN OIL COMPANY, DHAHRAN (SA)

(21) Appl. No.: 18/834,385

(22) PCT Filed: Jun. 12, 2024
(86) PCT No.: PCT/CN2024/098709

§ 371 Date: Jul. 30, 2024

(51) Int. Cl. G01V 1/50

(52) U.S. Cl. CPC G01V 1/50; G01V 2210/6222

(57) ABSTRACT

A method for training travel time-based networks and building an image of a velocity model includes obtaining a seismic dataset of seismic traces and determining an observed travel time for each seismic trace. The method further includes obtaining a velocity network, that depends on one or more velocity parameters, and a travel time network, that depends on one or more travel time parameters. The method further includes training the velocity network and the travel time network using a cost function and an optimizer. The cost function is based on the travel times parameters, the velocity parameters, a travel times equation, a derivative of the travel times equation, and a travel time mismatch between a first observed travel time and a first travel time value output by the travel time network. The method further includes building the image of a velocity model using the trained velocity network.

### BACKGROUND

Seismic images provide valuable subsurface information that may be used, for example, to help decision makers identifying drilling targets related to the extraction of natural resources. To build a seismic image, multiple steps are necessary, among which velocity model building is one of the most critical and challenging.

Building an accurate velocity model with conventional methods, such as ray-tracing tomography and full waveform inversion, requires a large amount of seismic data, a complex physical model that captures the intricacies of wave propagation through the subsurface, and an accurate numerical scheme that discretizes the physical model on a fine spatial grid. Therefore, velocity analysts are often left with the choice of building an accurate velocity model at a high computational cost, or compromising on the quality of the velocity model at a lower computational cost.

Accordingly, there is a clear and pressing need for a method for building accurate velocity models with a reduced computational cost.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for training travel time-based networks and building an image of a velocity model. The method includes obtaining, from a data acquisition system, a seismic dataset of seismic traces pertaining to a region of interest, where each seismic trace within the seismic dataset includes a seismic source location and a seismic receiver location. The method further includes determining, for each seismic trace within the seismic dataset, an observed travel time between the seismic source location of the seismic trace and the seismic receiver location of the seismic trace. The method further includes obtaining a trainable velocity network configured to receive, as input, a prediction location in the region of interest and return, as output, a velocity value, where the trainable velocity network depends on one or more velocity parameters. The method further includes obtaining a trainable travel time network configured to receive, as input, a source location and a prediction location and return, as output, a travel time value, where the trainable travel time network depends on one or more travel time parameters. The method further includes training the trainable travel time network and the trainable velocity network and building the image of a velocity model using the trainable velocity network and one or more trained velocity parameters. Training the trainable travel time network and the trainable velocity network includes obtaining a travel times equation modeling a travel time of n seismic wave in the region of interest according to a seismic velocity, the travel times equation based on the trainable travel time network and the trainable velocity network. Training the trainable travel time network and the trainable velocity network further includes constructing a cost fiction configured to receive, as inputs, the one or more travel times parameters and the one or more velocity parameters and return, as output, a cost. The cost is based on the travel times equation, a derivative of the travel times equation, and a travel time mismatch between a first observed travel time between a first seismic source location and a first seismic receiver location, and a first travel time value output by the trainable travel time network upon receiving, as inputs, the first seismic source location and the first seismic receiver location. Training the trainable travel time network and the trainable velocity network further includes computing, with an optimizer, one or more trained travel times parameters and the one or more trained velocity parameters, where the optimizer is configured to seek to minimize the cost function.

In one aspect, embodiments disclosed herein relate to a method for determining a velocity model from a trained velocity network. The method includes obtaining a first plurality of prediction locations discretizing a region of interest and obtaining the trained velocity network configured to receive, as input, a prediction location in the region of interest and return, as output, a velocity value at the prediction location, the trained velocity network based on one or more trained velocity parameters, where the one or more trained velocity parameters are determined by using an optimizer that seeks to minimize a cost function. The cost function is based on a travel times equation and a derivative of the travel times equation. The travel times equation models a travel time of a seismic wave in the region of interest according to a seismic velocity and is based on a trainable velocity network and a trainable travel time network. The trainable velocity network is based on one or more velocity parameters. The one or more velocity parameters are received by the cost function as inputs. The trained velocity network is obtained upon replacing, in the trainable velocity network, the one or more velocity parameters with the one or more trained velocity parameters. The method further includes determining a velocity model for the region of interest. The velocity model includes one velocity value for each prediction location within the first plurality of prediction locations. For each prediction location, the velocity value is determined by inputting the prediction location to the trained velocity network.

In one aspect, embodiments disclosed herein relate to a system for training travel time-based networks. The system includes a seismic acquisition system configured to acquire a seismic dataset of seismic traces pertaining to a region of interest, where each seismic trace within the seismic dataset includes a seismic source location and a seismic receiver location and where, for each seismic trace, a receiver at the seismic receiver location of the seismic trace detects ground motion of a seismic wave radiating from the seismic source location of the seismic trace. The system further includes a seismic processing system, configured to receive the seismic dataset from the seismic acquisition system and determine, for each seismic trace within the seismic dataset, an observed travel time between the seismic source location of the seismic trace and the seismic receiver location of the seismic trace. The system is further configured to form a trainable velocity network configured to receive, as input, a prediction location in the region of interest and return, as output, a velocity value, where the trainable velocity network depends on one or more velocity parameters. The system is further configured to form a trainable travel time network configured to receive, as input, a source location and a prediction location and return, as output, a travel time value, where the trainable travel time network depends on one or more travel time parameters. The system is further configured to train the trainable travel time network and the trainable velocity network. Training the trainable travel time network and the trainable velocity network includes obtaining a travel times equation modeling a travel time of a seismic wave in the region of interest according to a seismic velocity, the travel times equation based on the trainable travel time network and the trainable velocity network. Training the trainable travel time network and the trainable velocity network further includes constructing a cost function configured to receive, as inputs, the one or more travel times parameters and the one or more velocity parameters and return, as output, a cost. The cost is based on the travel times equation, a derivative of the travel tines equation and a travel time mismatch between a first observed travel time between a first seismic source location and a first seismic receiver location and a first travel time value output by the trainable travel time network upon receiving, as inputs, the first seismic source location and the first seismic receiver location. Training the trainable travel time network and the trainable velocity network further includes computing, with an optimizer, one or more trained travel times parameters and one or more trained velocity parameters, where the optimizer is configured to seek to minimize the cost function.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts a seismic acquisition system in accordance with one or more embodiments disclosed herein.

FIG. 2 depicts a system for training a trainable velocity network and a trainable travel time network in accordance with one or more embodiments disclosed herein.

FIG. 3 depicts a system for using a trained velocity network (305) to produce a velocity model in accordance with one or more embodiments disclosed herein.

FIG. 4 depicts a system for identifying and drilling through a drilling target in accordance with one or more embodiments disclosed herein.

FIG. 5 depicts a well drilling site in accordance with one or more embodiments disclosed herein.

FIG. 6 depicts a method for training travel time based artificial intelligence networks in accordance with one or more embodiments disclosed herein.

FIG. 7 depicts a method for using a trained velocity network to compute a velocity model in a region of interest among other uses, in accordance with one or more embodiments disclosed herein.

FIG. 8 depicts an example diagram of a neural network, in accordance with one of more embodiments disclosed herein in accordance with one or more embodiments disclosed herein.

FIG. 9 depicts an example diagram of a computer in accordance with one or more embodiments disclosed herein.

FIG. 10 depicts schematic example implementation of a training procedure in accordance with one or more embodiments disclosed herein.

FIG. 11A depicts an original velocity model in accordance with one or more embodiments disclosed herein.

FIG. 11B depicts an initial velocity model in accordance with one or more embodiments disclosed herein.

FIG. 11C depicts a final velocity model in accordance with one or more embodiments disclosed herein.

FIG. 11D depicts a difference in accordance with one or more embodiments disclosed herein.

FIG. 12 depicts example training source locations and training locations in accordance with one or more embodiments disclosed herein.

FIG. 13 depicts example training source locations and training locations in accordance with one or more embodiments disclosed herein.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “au,” and “the” include plural referents unless the context clearly dictates otherwise. For example, a computer may reference two or more such computers.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may of may not occur. The description includes instances where the event or circumstance occurs and instances where it does not occur.

Terms such as “approximately,” “about,” “substantially,” etc., mean that the recited characteristic, parameter, or value need not be achieved exactly, but that deviations of variations, including for example, tolerances, measurement error, measurement accuracy limitations and other factors known to those of skill in the art, may occur in amounts that do not preclude the effect the characteristic was intended to provide. For example, these terms may mean that there can be a variance in value of up to ±10%, of up to 5%, of up to 2%, of up to 1%, of up to 0.5%, of up to 0.19%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

It is to be understood that one or more of the steps shown in a flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

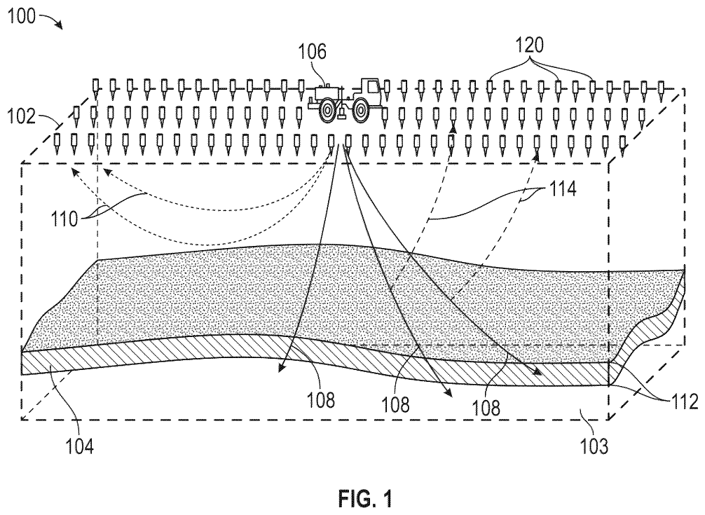

In the following description of FIGS. 1-13, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Methods and systems are disclosed for generating velocity models of a region of interest, from seismic data, using physics-informed machine learning. The velocity models may be subsequently used for identifying drilling targets in a subsurface, such as natural resource reservoirs, among other uses. Wells are drilled to perforate the drilling targets. The drilled wells may be used to extract natural resources, among other uses.

The term “seismic dataset” as used herein broadly means any dataset received and/or recorded as part of the seismic surveying process, or simulated, including particle displacement, velocity and/or acceleration, pressure and/or rotation, wave reflection, and/or refraction data. One with ordinary skill in the art will recognize that, in general, a seismic dataset may be inferred or otherwise derived from data received and/or recorded as part of a seismic surveying process. Thus, this disclosure may at times refer to a “seismic dataset and/or dataset derived therefrom,” or equivalently simply to a “seismic dataset” Both terms are intended to include both a measured/recorded seismic dataset and such a derived dataset, unless the context clearly indicates that only one of the other is intended. A properly processed seismic dataset may aid in decisions as to if and where to drill for a drilling target. A seismic trace may be a time series, with samples at monotonically increasing times, or after some processing, a depth series with samples at monotonically increasing depths.

The terms “velocity model,” “density model,” “physical property model,” or other similar terms as used herein refer to a numerical representation of parameters for subsurface regions. In some embodiments, the numerical representation may include an array of numbers, typically a 2-D or 3-D array, where each number represents the value of a physical property, such as velocity, density, or other physical property, at a point in, or a portion (cell) of, the subsurface. Each number may be called a “model parameter”. A subsurface region may be conceptually divided into a plurality of discrete cells for computational purposes (i.e., discretized). For example, the spatial distribution of velocity may be modeled using constant-velocity units (layers) through which is ray paths, obeying or modeled according to Snell's law, can be traced. In other cases, the subsurface may be modeled as an array of tetrahedral or cuboidal cells.

A seismic velocity is a velocity at which seismic waves propagate through a subsurface material. Different subsurface materials may exhibit different seismic velocities. A seismic velocity includes, at least, a speed of sound. In some embodiments, the seismic velocity further includes other components that account for anisotropic propagation. Throughout this disclosure, a number of components of the seismic velocity is denoted as D_{V}. All components of the seismic velocity are real numbers. The first component of the seismic velocity is the speed of sound. In scenarios where D_{V}=1, the seismic velocity is said to be isotropic, and the unique component of the seismic velocity is the speed of sound. A velocity model represents an estimate of the seismic velocity. A velocity model may be determined from a seismic dataset using a variety of methods, known to a person of ordinary skill in the art, collectively called “velocity analysis.” A geological model is a spatial representation of a distribution of sediments and rocks (rock types) in the subsurface.

FIG. 1 shows a seismic acquisition system (100) of a region of interest. The region of interest includes a surface (102) and a subsurface (103). The subsurface (103) may contain a reservoir (104). In general, seismic acquisition systems may be configured in a myriad of ways. Therefore, the seismic acquisition system (100) is not intended to be limiting with respect to the invention. The particular configuration of the seismic acquisition system equipment or location is merely intended as an illustration. In FIG. 1, the seismic acquisition system (100) is depicted as being on land, and a seismic source (106) is mounted on a land vehicle. In other examples, the seismic acquisition system (100) may be offshore, and the seismic source towed behind a seismic vessel.

The region of interest may be three-dimensional or two-dimensional. If the region of interest is three-dimensional, a referential is given by an origin point O on a plane [symbol] containing the surface (102), two non-parallel axes χ and [symbol] coplanar to [symbol] , and a depth axis [symbol] , orthogonal to [symbol] and directed toward the subsurface (103). A location (i.e., a point) X in the region of interest is uniquely defined by its coordinates (x, y, z), measured from the origin O, with respect to the axes χ, [symbol] and [symbol] respectively. A location (i.e., a point) X on the surface (102) is uniquely defined by its coordinates (x, y), measured from the origin O, with respect to the axes χ, [symbol] respectively. If the region of interest is two-dimensional, the surface (102) is a line. A referential is given by an origin point O on a line [symbol] containing the surface (102), an axis χ parallel to [symbol] , and a depth axis [symbol] , orthogonal to [symbol] and directed toward the subsurface (103). A location (i.e., a point) X in the region of interest is uniquely defined by its coordinates (x, y), measured from the origin O, with respect to the axes χ and [symbol] respectively. A location (i.e., a point) X on the surface (102) is uniquely defined by its coordinate x, measured from the origin O, with respect to the axis χ.

The seismic acquisition system (100) may utilize the seismic source (106) on the surface of the earth that, when fired, generates radiated seismic waves (108) into the subsurface (103). The radiated seismic waves (108) include pressure waves and shear waves. In one or more embodiments, the seismic source (106) fires at a location, (xₛ, yₛ), for a duration, Tₛ, then stops. During the seismic acquisition system (100), the seismic source (106) may fire multiple times, at different locations, hence illuminating the whole subsurface (103). In this disclosure, each activation of the seismic source (106), occurring at a distinct time, is also called a seismic source (106). Then, the seismic acquisition system (100) is said to have multiple seismic sources. Part of the radiated seismic waves (108) may return to the surface as refracted seismic waves (110). Part of the radiated seismic waves (108) may be reflected by geological reflectors (112) and return to the surface as reflected seismic waves (114).

At the surface, seismic receivers (120) detect signals of many kinds. Notable examples of signals received by the seismic receivers (120) include the refracted seismic waves (110) and the reflected seismic waves (114) that return to the surface. Examples of signals that may be detected by the seismic receivers (120) further include waves that reflect multiple times within the subsurface, known as multiple reflections. Examples of signals that may be detected by the seismic receivers (120) further include signal that does not originate from the seismic source (106). Signal that does not originate from the seismic source (106) may be referred to as noise. Examples of noise that may be detected by the seismic receivers (120) include, depending on where the seismic acquisition system (100) is located, ground roll, engine noise, swell noise, propeller noise, equipment damage noise and interferences from a seismic source from another seismic acquisition system. Examples of seismic receivers (120) include geophones, hydrophones, or any combination thereof.

The seismic source (106) and seismic receivers (120) may be of various types. In one or more embodiments, the region of interest is located onshore and the seismic source (106) is a seismic vibrator (e.g., mounted on a land vehicle) and the seismic receivers (120) are geophones. A land vehicle may carry the seismic source to different locations to complete the seismic acquisition. The geophones may also be moved anytime during the seismic acquisition, by humans or another vehicle. In other embodiments, the region of interest is located offshore and the seismic source (106) is an array of air guns mounted on a seismic vessel. In these embodiments, during the seismic acquisition, the seismic source (106) is moved to different locations via the motion of the seismic vessel. Additionally, the seismic receivers (120) may be geophones, hydrophones, or a combination thereof. The seismic receivers (120) may be located inside cables that are towed by the seismic vessel, or inside ocean bottom nodes (OBN). During a seismic acquisition using OBN, the OBN may be moved to different locations by a machine, such as a submarine vehicle. Generally, a geophone records a velocity of particles that are moved by a seismic wave, such as a pressure wave or a shear wave, that reach the geophone. Generally, a hydrophone records a pressure of seismic waves that reaches the hydrophone. It is emphasized that the examples of seismic acquisition and equipment used for the seismic acquisition herein are given only as examples and should not be considered limiting. One with ordinary skill in the art will recognize that other examples of seismic acquisition and equipment used for the seismic acquisition may be used without departing from the scope of this disclosure.

In one or more embodiments, each seismic receiver (120) includes a recorder, that records the amplitudes of the signals detected by the seismic receiver (120) at a sequence of discreet times throughout the survey. The recorded amplitudes at each of these discreet times is called a sample. Then, for each seismic receiver (120), a seismic trace is defined. Therefore, a distinct seismic trace is formed, for each seismic source activation and for each seismic receiver (120). The seismic trace includes an ordered set of samples (i.e., time series) recorded from a time when a seismic source starts firing, for a predefined duration, Tₘₐₓ, known as the trace length. The distinct seismic trace includes a time series of signal amplitudes recorded at discreet times discretizing a time interval of length Tₘₐₓ. In some embodiments, the trace length Tₘₐₓ is a fixed number of seconds. In some embodiments, the trace length Tₘₐₓ is a fixed number selected between eight seconds and fourteen seconds. The set of discreet times discretizing the time interval for a seismic trace is called a time sampling of the seismic trace. For simplicity, the time interval, for each seismic trace, is translated to the interval [0, Tₘₐₓ], and each sample of the seismic trace is said occur at a certain tune in the interval [0, Tₘₐₓ]. In one or more embodiments, the time sampling is constant for each seismic trace, and the time elapsed between two discreet times is called a sample rate of the seismic acquisition system (100).

For a three-dimensional region of interest, denoting (xₛ, y_{d}) as the location of a seismic source (106) and (xᵣ, yᵣ) as the location of a seismic receiver (120), a seismic trace is localized by the four coordinates (xₛ, yₛ, xᵣ, yᵣ), and a sample of the seismic trace is localized by five coordinates, (xₛ, yₛ, xᵣ, yᵣ, t), where t denotes the time at which the sample occurs on the time interval [0, Tₘₐₓ]. The set of all seismic traces, for all seismic source locations and all seismic receivers constitutes a five-dimensional seismic dataset. For a two-dimensional region of interest, denoting xₛ as the location of a seismic source (106) and xᵣ as the location of a seismic receiver (120), a seismic trace is localized by the two coordinates (xₛ, xᵣ), and a sample of the seismic trace as localized by three coordinates, (xₛ, xᵣ, t), where t denotes the time at which the sample occurs on the time interval [0, Tₘₐₓ]. The set of all seismic traces, for all seismic source locations and all seismic receivers constitutes a three-dimensional seismic dataset.

The term “velocity model” is defined as an estimate of a seismic velocity in the region of interest, or a portion of the region of interest. A seismic dataset may be processed to generate a velocity model of the region of interest or an image of seismic reflectors within the region of interest. Seismic reflectors may represent geological boundaries, such as boundaries between geological lavers, boundaries between different pore fluids, faults, fractures or groups of fractures within the rock. Generally, processing a seismic dataset comprises a sequence of steps designed, without limitation, to do one or more of the following: correct for near surface effects; attenuate noise; compensate for irregularities in the seismic acquisition system geometry; calculate a depth velocity model; image reflectors in the subsurface; calculate a plurality of seismic attributes to characterize the subsurface (103), and aid in identifying drilling targets.

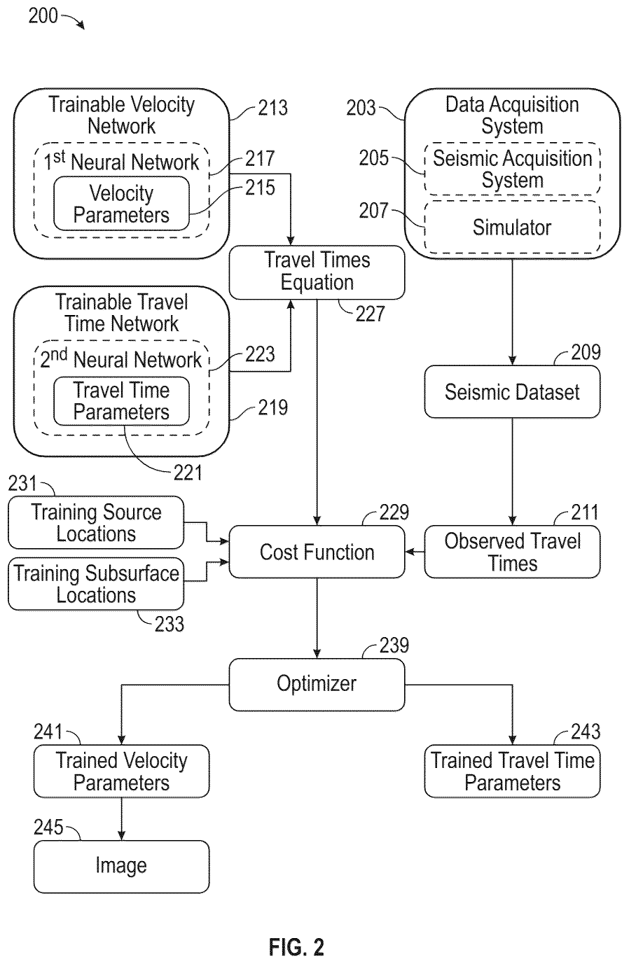

FIG. 2 depicts a system (200) for training a trainable velocity network (213) and a trainable travel time network (219), in accordance with one or more embodiments. A seismic dataset (209), pertaining to a region of interest, is obtained from a data acquisition system (203). The region of interest is composed of a subsurface in the Earth and a boundary of the subsurface. In some embodiments, the boundary of the subsurface, and thus, the region of interest, includes an area of the surface of the Earth. The number of dimensions of the region of interest is denoted as D. The data acquisition system (203) may be configured in many ways. In some embodiments, the data acquisition system (203) includes a seismic acquisition system (205), similar to the seismic acquisition system (100) in FIG. 1. In other embodiments, the data acquisition system (203) includes a simulator (207), configured to generate the seismic dataset (209). Examples of simulators configured to generate a seismic dataset include a wave propagator.

The wave propagator is configured to simulate the propagation of a seismic wave from a synthetic seismic source location to a synthetic seismic receiver location. The wave propagator returns, as output, a synthetic seismic trace modeling the seismic response that would be recorded by a seismic receiver located at the synthetic seismic receiver location if a seismic signal were emitted by a seismic source located at the synthetic seismic source location. In some embodiments, the wave propagator is based on a wave equation. In some embodiments, the wave propagator is based on a ray tracing equation. In some embodiments, the wave propagator makes use of a seismic velocity in the region of interest. The seismic velocity includes a speed of a seismic wave of the region of interest. The seismic velocity may be isotropic or anisotropic and include other components, in addition to the speed of the seismic wave. The seismic velocity may be obtained in many ways. In some embodiments, the seismic velocity is synthetic. In other embodiments, the seismic velocity is defined by one or more velocity analysis methods known in the art, and briefly described later in this disclosure. In further embodiments, the seismic velocity is obtained from another seismic project, called a legacy seismic project, that was previously completed in an area that includes the region of interest.

The seismic dataset (209) includes one or more seismic traces. If the data acquisition system (203) includes the simulator (207), the seismic traces include synthetic seismic traces obtained by the simulator (207). Each seismic trace within the seismic dataset (209) includes a seismic source location and a seismic receiver location. For a seismic trace acquired by the seismic acquisition system (205), the seismic source location of the trace is a location of the seismic source that was fired to acquire the seismic trace. For a seismic trace acquired by the seismic acquisition system (205), the seismic receiver location of the trace is a location of a receiver that recorded the seismic trace. For a seismic trace simulated by the simulator (207), the seismic source location of the trace is a synthetic seismic source location that was used to simulate the seismic trace. For a seismic trace simulated by the simulator (207), the seismic receiver location of the trace is a synthetic seismic receiver location that was used to simulate the seismic trace.

Observed travel times (211) are determined from the seismic dataset (209). The observed travel times (211) include one observed travel time for each seismic trace within the seismic dataset (209). For each seismic trace within the seismic dataset (209), the observed travel time is denoted as T_{obs}(S, R), where S is the seismic source location of the seismic trace and R is the seismic receiver location of the seismic trace. For each seismic trace within the seismic dataset (209), the observed travel time may be obtained in many ways. In one or more embodiments, the observed travel time is defined as a first arrival on the seismic trace. The first arrival is defined as a time of arrival of an earliest refracted signal on the seismic trace. The earliest refracted signal originates from a seismic wave emitted by the seismic source that is used to obtain the seismic trace. The first arrival represents a shortest travel time of a seismic wave from the seismic source location of the seismic trace to the seismic receiver location of the seismic trace.

A trainable velocity network (213), N_{V}, depending on one or more velocity parameters (215) α_{V}, is configured to receive, as input, a prediction location X in the region of interest and returns, as output, a velocity value N_{V}(π_{V}, X). The velocity value N_{V}(α_{V}, X) is a vector with D_{V} real components. The first component

$${N}_{V}^{1} ( {α}_{V} , X ) ,$$

represents a speed of sound. Each parameter among the velocity parameters (215) α_{V} is a real number. The velocity parameters (215) α_{V} may be written as a vector of real numbers in [symbol] , where M_{V} denotes the number of parameters within the velocity parameters (215) α_{V}. The trainable velocity network (213) is a first machine learning model that may be configured in many ways. The trainable velocity network (213) may include one or more machine learning algorithms. Examples of machine learning algorithms that may be included m the trainable velocity network (213) include supervised machine learning algorithms capable of performing a regression, such as a decision tree regressor, a polynomial regression model, a non-linear regression model, or any combination thereof. In one or more embodiments, the trainable velocity network (213) includes a first neural network (217). In one or more embodiments, the trainable velocity network (213) is the first neural network (217). The first neural network (217) includes parameters, such as one or more weights, one or more biases, or any combination thereof. The parameters of the first neural network (217) are included in, or equal to, the velocity parameters (215) α_{V}. The first neural network (217) may be configured in many ways. The first neural network (217) may include, for example, a fully connected neural network, a convolutional neural network, a recurrent neural network (RNN), a long short term memory (LSTM) network, a gated recurrent unit (GRU), a transformers model, or any combination of fully connected, convolutional, recurrent, LSTM, GRU, normalization, pooling, dropout and regularization layers. The first neural network (217) may include other components or structures outside of the ones described herein without departing from the scope of this disclosure.

A trainable travel time network (219), N_{T}, depending on one or more travel time parameters (221) αₜ, is configured to receive, as input, a source location Xₛ in the region of interest, and a prediction location X in the region of interest. The trainable travel time network (219 is configured to return, as output, a travel time value N_{T}(α_{T}, X_{S}, X). The travel time value N_{T}(α_{T}, X_{S}, X) is a real number. Each parameter among the travel time parameters (221) α_{T} is a real number. The travel the parameters (221) α_{T}, may be written as a vector of real numbers in [symbol] , where M_{T} denotes the number of parameters among the travel time parameters (221) α_{T}. The trainable travel time network (219) is a second machine learning model that may be configured in many ways. The trainable travel time network (219) may include one or more machine learning algorithms. Examples of machine learning algorithms that may be included in the trainable velocity network (213) include supervised machine learning algorithms capable of performing a regression, such as a decision tree regressor, a polynomial regression model, a non-linear regression model, or any combination thereof. In one or more embodiments, the trainable travel time network (219) includes a second neural network (223). In one or more embodiments, the trainable travel time network (219) is the second neural network (223). The second neural network (223) includes parameters, such as one or more weights, one or more biases, or any combination thereof. The parameters of the second neural network (223) are included in, or equal to, the travel time parameters (221) α_{T}. The second neural network (223) may be configured in many ways. The second neural network (223) may include, for example, a fully connected neural network, a convolutional neural network, a recurrent neural network (RNN), a long short term memory (LSTM) network, a gated recurrent unit (GRU), a transformers model, or any combination of fully connected, convolutional, recurrent, LSTM, GRU, normalization, pooling, dropout and regularization layers. The second neural network (223) may include other components or structures outside of the ones described herein without departing from the scope of this disclosure.

A travel tune of a seismic wave between a source location and any location in the region of interest, including a receiver location, is given by a travel tines formula. Terms of the travel times formula include a travel time function T configured to receive, as inputs, a source location X, in the region of interest and a prediction location X in the region of interest. The travel time function T is configured to return, as output, a travel time T (Xₛ, X) between the source location Xₛ and the prediction location X. Terms of the travel times formula further include a velocity function V configured to receive, as input, a prediction location X in the region of interest and return, as output, a seismic velocity of a seismic wave at the prediction location X. The travel times formula may be written as:

$$F ( X , V , T ( {X}_{s} , . ) ) = 0. \qquad EQ . 1$$

In EQ. 1, the operator F receives, as inputs, a prediction location X, the velocity function V and the travel time function T. The function T (X_{s′}) receives, as input, a prediction location X and return, as output, the travel time T (Xₛ, X). In EQ. 1, the source location Xₛ is supposed to be invariable for the operator F. In one or more embodiments, the operator F includes a differential operator. In one or more embodiment, EQ. 1 is an Eikonal equation.

$$H ( X , V ( X ) , ∇ T ( {X}_{s} , X ) ) = 0 , \qquad EQ . 2$$

where H is a continuous function from [symbol] to [symbol] and the notation ∇ represent a gradient with respect to the space variables X. The number of dimensions of the region of interest is denoted as D and the number of components of the velocity is D_{V}. Examples for the Eikonal equation EQ. 2 include, but are not limited to, an isotropic Eikonal equation, assuming D_{V}=1:

$${‖ ∇ T ( {X}_{s} , X ) ‖}_{0} - \frac{1}{V ( X )} = 0 , \qquad EQ . 3$$

where the notation ∥⋅∥₀ represents a l^{p}₀-norm, with 1≤p₀≤∞.

A travel times equation (227) may be obtained by replacing, in the travel times formula EQ. 1, the travel time function T with the trainable travel time network (219) and the velocity function V with the trainable velocity network (213). Following EQ. 1, the travel times equation (227) reads:

$$F ( X , {N}_{V} ( {α}_{V} , . ) , {N}_{T} ( {α}_{T} , . , . ) ) = 0 , \qquad EQ . 4$$

In EQ. 4, the notation N_{V}(α_{V},.) denotes the application X→N_{V}(α_{V},X) and the notation N_{T}(α_{T}, ., .) denotes the application (X_{g},X)→N_{T}(α_{T},Xₛ,X). In implementations where the travel times formula is the Eikonal EQ. 2, the travel times equation (227) is:

$$H ( X , {N}_{V} ( {α}_{V} , X ) , ∇ {N}_{T} ( {α}_{T} , {X}_{s} , X ) ) = 0. \qquad EQ . 5$$

In embodiments where the travel times formula is the isotropic Eikonal EQ. 3, the travel times equation (227) is, assuming D_{V}=1:

$${‖ ∇ {N}_{T} ( {α}_{T} , {X}_{s} , X ) ‖}_{0} - \frac{1}{{N}_{V} ( {α}_{V} , X )} = 0. \qquad EQ . 6$$

A cost function (229), denoted as L, is formed, based on the observed travel times (211), the travel times equation (227) and one or more derivatives of the travel times equation (227). The cost function (229) receives, as inputs, the velocity parameters α_{V} and the travel time parameters α_{T}. The cost function (229) returns as output, a cost, denoted as L(α_{V},α_{T}), based on the input velocity parameters α_{V} and travel time parameters α_{T}. The cost function (229) is based on one or more travel time mismatches. A travel time mismatch is defined, for each seismic trace within the seismic dataset (209), as a difference between T_{obs}(S,R) and N_{T}(α_{T}, S, R), namely, T_{obs}(S,R)−N_{T}(α_{T}, S, R). The seismic dataset (209) is split into a training seismic dataset and a testing seismic dataset. The seismic traces of the training seismic dataset are called training seismic traces. The seismic traces of the testing seismic dataset are called testing seismic. It is common practice to split the seismic dataset (209) in a way that the training seismic dataset contains more seismic traces than the testing seismic dataset. Because data splitting is a common practice when training and testing a machine-learned model, it is not described in detail m this disclosure.

One of ordinary skill in the art will recognize that any data splitting technique may be applied to the seismic dataset (209) without departing from the scope of the invention. In some embodiments, the training seismic dataset is the whole seismic dataset (209). Denoting m, as a number of seismic source locations of the seismic traces in the training seismic dataset, the seismic source locations of the traces in the training seismic dataset are denoted as Sᵢ, for 1≤i≤m_{g}. For each seismic source location Sᵢ, the number of seismic receiver locations of the seismic traces of the training seismic dataset that have Sᵢ as a seismic source location is denoted as mᵢ. The seismic receiver locations are denoted as R_{i,j}, for 1≤j≤mᵢ. The cost function (229) is based on the mismatches d_{i,j}=T_{obs}(Sᵢ,R_{i,j})−N_{T}(α_{T}, Sᵢ, R_{i,j}), for 1≤i≤mₛ, for 1≤j≤mᵢ.

Denoting d as a vector with components d_{i,j} for 1≤i≤mₛ, for 1≤j≤mᵢ, the cost function (229) includes a first term:

$${A}_{1} ( {α}_{T} ) = {G}_{1} ( {‖ d ‖}_{1} ) . \qquad EQ . 7$$

where G₁ is an increasing function [symbol] → [symbol] such that G₁(0)=0, and the notation ∥⋅∥₁ represents a first norm, such as, for example, an l^{p}^{₁}-norm, with 1≤p₁≤∞. It is noted that a function, g: [symbol] → [symbol] is said to be increasing if, for all non-negative numbers u₁ and u₂ such that u₁<u₂, g satisfies g(u₁)<g(u₂). In some embodiments, the fast term A₁(α_{T}) is interpreted as measuring an average mismatch between the observed travel times (211) and the travel time values computed by the trainable travel time network (219). In some implementations, the function G, is the square function and the first norm ∥∩∥₁ is a weighted l²-norm. In such embodiments, EQ. 7 becomes:

$${A}_{1} ( {α}_{T} ) = \frac{1}{{\sum }_{j = 1}^{i = {m}_{s}} {m}_{i}} {\sum }_{i = 1}^{i = {m}_{s}} {\sum }_{j = 1}^{j = {m}_{i}} {δ}_{i , j}^{1} {\vert {T}_{obs} ( {S}_{i} , {R}_{i , j} ) - {N}_{T} ( {α}_{T} , {S}_{i} , {R}_{i , j} ) \vert}^{2} . \qquad EQ . 8$$

In EQ. 8, the coefficients

$${δ}_{i , j}^{1}$$

are non-negative real numbers, at least some of which must be non-zero, which means that

$${δ}_{i , j}^{1} \geq 0$$

1≤i≤mₛ, for 1≤j≤mᵢ, and

$${\sum }_{i = 1}^{i = {m}_{s}} {\sum }_{j = 1}^{j = {m}_{i}} {δ}_{i , j}^{1} > 0.$$

The coefficients

$${δ}_{i , j}^{1}$$

can be defined in many wats. In some implementations,

$${δ}_{i , j}^{1} = 1$$

for all 1≤i≤mₛ, for 1≤j≤mᵢ, meaning that all seismic source locations and seismic receiver locations are equally weighted in EQ. 8. In other implementations, the coefficients

$${δ}_{i , j}^{1}$$

are switches configured to select a subset of pairs of seismic source locations and seismic receiver locations. For instance, in some implementations, for a first subset IC{(i,j),i∈[1,mₛ],j∈[1,mᵢ]}, the coefficients

$${δ}_{i , j}^{1}$$

are defined as

$${δ}_{i , j}^{1} = 1$$

for all (i,j)∈I, and

$${δ}_{i , j}^{1} = 0$$

for all (i,j)∉I.

The cost function (229) is further based on the travel times equation (227). There are many configurations in which the cost function (229) may be based on the travel times equation (227). In one or more embodiments, a number of nₛ≥1 training source locations (231) are selected, denoted as X_{s,i}, for 1≤i≤nₛ, and a number of nₚ≥1 of training locations (233) are selected and denoted as Xⱼ, for 1≤j≤nₚ. The training source locations (231) X_{s,i} may be selected in many ways. In one or more embodiments, the training source locations (231) are selected manually. In some embodiments, the boundary of the region of interest includes a surface of the Earth, such as the surface (102) in FIG. 1, and the training source locations (231) are selected on the surface. In some embodiments, the training source locations (231) discretize the surface, in a same way as shot locations are positioned in a conventional acquisition. In some embodiments, the training source locations (231) are located on a substantially straight line on the surface, modeling a shot line in a conventional acquisition. In some embodiments, the training source locations (231) are located in same locations as seismic source locations Sᵢ, for one or more integers i on the interval [1,mₛ]. In some embodiments, the training source locations (231) are the seismic source locations Sᵢ, meaning that nₛ=mₛ and X_{s,i}=Sᵢ, for 1≤i≤nₛ. In some embodiments, the training source locations (231) are selected randomly.

The training locations (233) Xⱼ may be selected in many ways. For example, in one or more embodiments, the training locations (233) are selected manually. In some embodiments, the training locations (233) discretize the region of interest, while in other embodiments, the training locations (233) form a regular grid that discretizes the region of interest, and in still other embodiments, the training locations (233) are selected randomly. It is noted that the training source locations (231) and training locations (233) may be located anywhere m the region of interest. One with ordinary skill in the art will readily appreciate that the partitioning and organization of the training source locations (231) and training locations (233) is intended to promote clear discussion and should not be considered fixed or limiting.

The cost function (229) includes a second term that evaluates the travel times equation (227) EQ. 4 at the training source locations (231) and training locations (233). Denoting h as a vector with components h_{i,j}=F(Xⱼ, N_{V}(α_{V},Xⱼ),N_{T}(α_{T}, X_{s,i}, Xⱼ)), for 1≤i≤nₛ, for 1≤j≤mᵢ, for 1≤j≤nₚ, the second term is defined by:

$${A}_{2} ( {α}_{V} , {α}_{T} ) = {G}_{2} ( {‖ h ‖}_{2} ) , \qquad EQ . 9$$

where G₂ is an increasing function [symbol] → [symbol] such that G₂(0)=0, and the notation ∥⋅∥₂ represents a second norm, such as, for example, an l^{p}^{₂}-norm, with 1≤p₂≤∞. In some embodiments, the second term A₂(α_{T}, α_{T}) is interpreted as aiming to enforce EQ. 4. In some implementations, the function G₂ is the square function and the second non ∥∩∥₂ is a weighted l²-norm. In such embodiments, EQ. 9 becomes:

$${A}_{2} ( {α}_{V} , {α}_{T} ) = \frac{1}{{n}_{s} {n}_{p}} {\sum }_{i = 1}^{i = {n}_{s}} {\sum }_{j = 1}^{j = {n}_{p}} {δ}_{i , j}^{2} {\vert F ( {X}_{j} , {N}_{V} ( {α}_{V} , {X}_{j} ) , {N}_{T} ( {α}_{T} , {X}_{s , i} , {X}_{j} ) ) \vert}^{2} . \qquad EQ . 10$$

In EQ. 9, the coefficients

$${δ}_{i , j}^{2}$$

are non-negative real numbers that cannot be all zeros, which means that

$${δ}_{i , j}^{2} \geq 0$$

for 1≤i≤nₛ, for 1≤j≤nₚ, and

$${\sum }_{i = 1}^{i = {n}_{s}} {\sum }_{j = 1}^{j = {n}_{p}} {δ}_{i , j}^{2} > 0.$$

The coefficients

$${δ}_{i , j}^{2}$$

can be defined in many ways. In some implementations,

$${δ}_{i , j}^{2} = 1$$

for all 1≤i≤nₛ, for all 1≤j≤nₚ, meaning that all training source locations (231) and training locations (233) are equally weighted in EQ. 9. In other implementations, the coefficients

$${δ}_{i , j}^{2}$$

are switches configured to select a subset of pairs of training source locations (231) and training locations (233). For instance, in some implementations, for a first subset IC[1, nₛ] and a second subset JC[1, nₚ], the coefficients

$${δ}_{i , j}^{2}$$

are defined as

$${δ}_{i , j}^{2} = 1$$

for all (i,j)∈I×J, and

$${δ}_{i , j}^{2} = 0$$

if i∉I or j∉J. In implementations where the travel times equation is an Eikonal equation. EQ. 10 becomes, by virtue of EQ. 5:

$${A}_{2} ( {α}_{V} , {α}_{T} ) = \frac{1}{{n}_{s} {n}_{p}} {\sum }_{i = 1}^{i = {n}_{s}} {\sum }_{j = 1}^{j = {n}_{p}} {δ}_{i , j}^{2} {\vert H ( X , {N}_{V} ( {α}_{V} , {X}_{j} ) , ∇ {N}_{T} ( {α}_{T} , {X}_{s , i} , {X}_{j} ) ) \vert}^{2} . \qquad EQ . 11$$

In implementations where the travel times equation is an isotropic Eikonal equation. EQ. 9 becomes, by virtue of EQ. 6:

$${A}_{2} ( {α}_{V} , {α}_{T} ) = \frac{1}{{n}_{s} {n}_{p}} {\sum }_{i = 1}^{i = {n}_{s}} {\sum }_{j = 1}^{j = {n}_{p}} {δ}_{i , j}^{2} {\vert {‖ ∇ {N}_{T} ( {α}_{T} , {X}_{s , i} , {X}_{j} ) ‖}_{0} - \frac{1}{{N}_{V} ( {α}_{V} , {X}_{j} )} \vert}^{2} . \qquad EQ . 12$$

The cost function (229) is further based on one or more derivatives of the travel times equation (227). The cost function (229) includes a third term that evaluates derivatives of the travel times equation (227) EQ. 4 at the training source locations (231) and training locations (233). Defining the function ƒ:(α_{V}, α_{T}, Xₛ, X)→ƒ(α_{V}, α_{T}, Xₛ, X)=F(X, N_{V}(α_{V},X), N_{T}(α_{T}, Xₛ, X)), the D derivatives of ƒ with respect to the space variables X are denoted as ∂ₖƒ, for 1≤k≤D, where ∂ₖƒ is the derivative of ƒ with respect to the k^{th} space variable (i.e., the k^{th} component of the space variable X). Thus, the derivative of ƒ with respect to the k^{th} space variable, evaluated at training source location X_{s,i} and training location Xⱼ is denoted by ∂ₖƒ(α_{V}, α_{T}, X_{s,i}, Xⱼ). For each distinct k, a vector rₖ denotes the vector with components r_{k,i,j}=∂ₖƒ(α_{V}, α_{T}, X_{s,i}, Xⱼ), for all 1≤i≤nₛ, for all 1≤j≤nₚ. The third term of the cost function (229) is defined as a D-dimensional vector:

$${A}_{3} ( {α}_{V} , {α}_{T} ) = ( \begin{matrix}{G}_{3} ( {‖ {r}_{1} ‖}_{3} ) \\ ⋯ \\ ⋯ \\ {G}_{3} ( {‖ {r}_{D} ‖}_{3} )\end{matrix} ) . \qquad EQ . 13$$

where G₃ is an increasing function [symbol] → [symbol] such that G₃(0)=0, and the notation ∥⋅∥₃ represents a third norm, such as, for example, an l^{p}^{₃}-norm, with 1≤p₃≤∞. In some embodiments, the third term A₃(α_{V},α_{T}) is interpreted as aiming to enforce derivatives of EQ. 4. In some implementations, the fiction G₃ is the square function and the third norm ∥⋅⋅₃ is a weighted l²-norm. In such embodiments. EQ. 13 becomes:

$${A}_{3} ( {α}_{V} , {α}_{T} ) = \frac{1}{{n}_{s} {n}_{p}} {\sum }_{i = 1}^{i = {n}_{s}} {\sum }_{j = 1}^{j = {n}_{p}} {δ}_{i , j}^{3} ( \begin{matrix}\vert {\partial }_{1} f ( {α}_{V} , {α}_{T} , {X}_{s , i} , {X}_{j} ) \vert \\ ⋯ \\ ⋯ \\ {\vert {\partial }_{D} f ( {α}_{V} , {α}_{T} , {X}_{s , i} , {X}_{j} ) \vert}^{2}\end{matrix} ) . \qquad EQ . 14$$

In EQ. 14, the coefficients

$${δ}_{i , j}^{3}$$

are non-negative real numbers that cannot be all zeros, which means that

$${δ}_{i , j}^{3} \geq 0$$

for 1≤i≤nₛ, for 1≤j≤nₚ, and

$${δ}_{i , j}^{2} > 0$$

The coefficients

$${δ}_{i , j}^{3}$$

can be defined in many ways, in a similar fashion to the coefficients

$${δ}_{i , j}^{2}$$

in EQ. 10. In some implementations,

$${δ}_{i , j}^{3} = 1$$

for all 1≤i≤nₛ, for all 1≤j≤nₚ, meaning that all training source locations (231) and training locations (233) are equally weighted in EQ. 14. In other implementations, the coefficients

$${δ}_{i , j}^{3}$$

are switches configured to select a subset of pairs of training source locations (231) and training locations (233).

In one or more embodiments, the travel times equation EQ. 1 is associated with an interface condition:

$$B ( ω , V , T ( {X}_{s′} , ) ) = 0. \qquad EQ . 15$$

for each interface location ω in an interface ∂Ω of the region of interest. The interface ∂Ω is defined as a subset of the region of interest. The interface ∂Ω is included in, but not equal to the region of interest. In EQ. 15, the operator B receives, as inputs, an interface location ω, the velocity function V and the travel time function T. The operator B is independent of the source location Xₛ. The function T(Xₛ,.) receives, as input, an interface location (and return, as output, a travel time T(Xₛ,ω) between the source location, Xₛ and the interface location ω. In EQ. 15, the source location Xₛ is supposed to be invariable for B. EQ. 15 may apply to multiple source locations Xₛ. In one or more embodiments, the operator B includes a differential operator. In some implementation, the interface condition in EQ 15 is a Dirichlet interface condition:

$$T ( {X}_{s} , ω ) - q ( ω ) = 0 , for ω ∈ \partial Ω , \qquad EQ . 16$$

where q is a given function from [symbol] to [symbol] . In some implementations, the interface ∂Ω is a source location Xₛ and the function q is such that q≡0, modeling that the shortest travel time from the source location Xₛ to itself is 0. In such implementations, EQ. 16 reduces to the zero-time condition:

$$T ( {X}_{s} , {X}_{s} ) = 0. \qquad EQ . 17$$

In one or more embodiments, the cost function (229) is based on the interface condition in EQ. 15. There are many ways in which the cost function (229) may be based on the interface condition in EQ. 15. In some implementations, a set of n_{ƒ}≥1 training interface locations ωᵢ are selected, for 1≤i≤n_{ƒ}, such that ωᵢ∈∂Ω, for 1≤i≤n_{ƒ}. Then, the interface condition is approximated by replacing T with N_{T}(α_{T}, ., .) and replacing V with N_{V} in EQ. 15. In such embodiments, denoting b as the vector with components b_{i,j}=B(ωⱼ, N_{V}(α_{V},.), N_{T}(α_{T}, X_{s,i}, .)) the cost function (229) includes a fourth term:

$${A}_{4} ( {α}_{V} , {α}_{T} ) = {G}_{4} ( {‖ b ‖}_{4} ) , \qquad EQ . 18$$

where G₄ is an increasing function [symbol] → [symbol] such that G₄(0)=0, and the notation ∥∩∥₄ represents a fourth norm, such as an l^{p}^{₄}-norm, with 1≤p₄≤∞.In some embodiments, the fourth term A₄(α_{V},α_{T}) is interpreted as aiming to enforce EQ. 15. In some implementations, the function G₄ is the square function and the second norm ∥∩∥₄ is a weighted l²-norm. In such embodiments. EQ. 18 becomes:

$${A}_{4} ( {α}_{V} , {α}_{T} ) = \frac{1}{{n}_{s} {n}_{f}} {\sum }_{i = 1}^{i = {n}_{s}} {\sum }_{j = 1}^{j = {n}_{f}} {δ}_{i , j}^{4} {\vert B ( {ω}_{j} , {N}_{V} ( {α}_{V} , . ) , {N}_{T} ( {α}_{T} , {X}_{x , i} , . ) ) \vert}^{2} . \qquad EQ . 19$$

In EQ. 19, the coefficients

$${δ}_{i , j}^{4}$$

are non-negative real numbers that cannot be all zeros, which means that

$${δ}_{i , j}^{4} \geq 0$$

for 1≤i≤nₛ, for 1≤j≤n_{ƒ}, and

$${\sum }_{i = 1}^{i = {n}_{s}} {\sum }_{j = 1}^{j = {n}_{p}} {δ}_{i , j}^{4} > 0.$$

The coefficients

$${δ}_{i , j}^{4}$$

can be defined in many ways. In some implementations,

$${δ}_{i , j}^{4} = 1$$

for all 1≤i≤nₛ, for all 1≤j≤n_{ƒ}, meaning that all training source locations (231) and training interface locations are equally weighted in EQ. 19. In other implementations, the coefficients

$${δ}_{i , j}^{4}$$

are switches configured to select a subset of pairs of training source locations (231) and training interface locations. For instance, in some implementations, for a first subset IC[1,nₛ] and a second subset JC[1,n_{ƒ}], the coefficients

$${δ}_{i , j}^{4}$$

are defined as

$${δ}_{i , j}^{4} = 1$$

for all (i,j)∈I×J, and

$${δ}_{i , j}^{4} = 0$$

if i∉I or j∉J. In implementations where the interface condition is the Dirichlet condition from EQ. 16, EQ. 19 reduces to:

$${A}_{4} ( {α}_{V} , {α}_{T} ) = \frac{1}{{n}_{s} {n}_{f}} {\sum }_{i = 1}^{i = {n}_{s}} {\sum }_{j = 1}^{j = {n}_{f}} {δ}_{i , j}^{4} {\vert {N}_{T} ( {α}_{T} {X}_{s , i} , {ω}_{j} ) - q ( {ω}_{j} ) \vert}^{2} . \qquad EQ . 20$$

In EQ. 18, the fourth term A₄(α_{V},α_{T}) does not depends on the velocity parameters α_{V}. In implementations where the interface condition is the zero-time condition from EQ. 17, the training interface locations ωᵢ are selected to be the same as the training source locations X_{s,i}, and the coefficients

$${δ}_{i , j}^{4}$$

are selected such that

$${δ}_{i , j}^{4} = 0$$

for i≠j. The remaining coefficients,

$${δ}_{i , i}^{4} ,$$

weight the training source locations X_{s,i}, for 1≤i≤nₛ. In such implementations, EQ. 20 reduces to:

$${A}_{4} ( {α}_{V} , {α}_{T} ) = \frac{1}{{n}_{s}} {\sum }_{i = 1}^{i = {n}_{s}} {δ}_{i , i}^{4} {\vert {N}_{T} ( {α}_{T} , {X}_{s , i} , {X}_{s , i} ) \vert}^{2} . \qquad EQ . 21$$

In one or more embodiments, the cost function (229) includes a fifth term that aims to enforce a non-negativity of the travel times N_{T}(α_{T}, X_{s,i}, Xⱼ) for 1≤i≤nₛ, for 1≤j≤nₚ. The fifth term is based on a vector α₁ with components α_{1,i,j}= [symbol] (−N_{T}(α_{T}, X_{s,i}, Xⱼ))N_{T}(α_{T}, X_{s,i}, Xⱼ), for 1≤i≤mₛ, for 1≤j≤nₚ, where the Heavyside function [symbol] , from [symbol] to [symbol] , is defined by [symbol] (t)=1 if t≥0, or [symbol] (t)=0 if t<0. The fifth term is defined by:

$${A}_{5} ( {α}_{T} ) = {G}_{5} ( {‖ {α}_{1} ‖}_{5} ) . \qquad EQ . 22$$

where G₅ is an increasing function [symbol] → [symbol] such that G₅(0)=0, and the notation ∥∩∥₅ represents a fifth norm, such as, for example, an l^{p}^{₅}-norm, with 1≤p₅≤∞. In some implementations, the function G₅ is the square function and the fifth norm ∥∩∥₅ is a weighted l²-norm. In such embodiments, EQ. 22 becomes:

$${A}_{5} ( {α}_{T} ) = \frac{1}{{n}_{s} {n}_{p}} {\sum }_{i = 1}^{i = {n}_{s}} {\sum }_{j = 1}^{j = {n}_{p}} {δ}_{i , j}^{5} ℋ ( - {N}_{T} ( {α}_{T} , {X}_{s , i} , {X}_{j} ) ) {\vert {N}_{T} ( {α}_{T} , {X}_{s , i} , {X}_{j} ) \vert}^{2} . \qquad EQ . 23$$

In EQ. 23, the coefficients

$${δ}_{i , j}^{5}$$

weigh the training source locations (231) and the training locations (233). The coefficients

$${δ}_{i , j}^{5}$$

are defined in a similar fashion to the coefficients

$${δ}_{i , j}^{2}$$

### in EQ. 10.

In one or more embodiments, the cost function (229) includes a sixth term that aims to enforce a lower bound, Vₘₐₓ≥0, for the speeds of sound

$${N}_{V}^{1} ( {α}_{V} , {X}_{j} ) ,$$

for 1≤j≤nₚ. The sixth term is based on a vector α₂ with components

$${α}_{2 , i , j} = ℋ ( {V}_{min} - {N}_{V}^{1} ( {α}_{V} , {X}_{j} ) ) ( {N}_{V}^{1} ( {α}_{V} , {X}_{j} ) - {V}_{min} ) , for 1 \leq j \leq {n}_{p} .$$

The sixth term is defined by:

$${A}_{6} ( {α}_{V} ) = {G}_{6} ( ‖ {α}_{2} {‖}_{6} ) , \qquad EQ . 24$$

where G₆ is an increasing function [symbol] → [symbol] such that G₆(0)=0, and the notation ∥⋅∥₆ represents a sixth norm, such as, for example, an l^{p}^{₆}-norm, with 1≤p₆≤∞. In some implementations, the function G₆ is the square function and the fifth norm ∥⋅∥₆ is a weighted l²-norm. In such embodiments. EQ. 24 becomes:

$${A}_{6} ( {α}_{V} ) = \frac{1}{{n}_{p}} {\sum }_{j = 1}^{j = {n}_{p}} {δ}_{j}^{6} ℋ ( {V}_{min} - {N}_{V}^{1} ( {α}_{V} , {X}_{j} ) ) {\vert {N}_{V}^{1} ( {α}_{V} , {X}_{j} ) - {V}_{min} \vert}^{2} . \qquad EQ . 25$$

In EQ. 25, the coefficients

$${δ}_{j}^{6}$$

are non-negative real numbers that cannot be all zeros, which means that

$${δ}_{j}^{6} \geq 0$$

for 1≤j≤nₚ, and

$${δ}_{j}^{6}$$

The coefficients

$${δ}_{j}^{6}$$

are weights given to each training location Xⱼ, for 1≤j≤nₚ. The coefficients

$${δ}_{j}^{6}$$

can be defined in many ways. In some implementations,

$${δ}_{j}^{6} = 1$$

for all 1≤j≤nₚ, meaning that all training locations (233) are equally weighted in EQ. 25. In other implementations, the coefficients

$${δ}_{j}^{6}$$

are switches configured to select a subset of the training locations (233). For instance, in some implementations for a first subset/C IC[1, nₚ], the coefficients

$${δ}_{j}^{6}$$

are defined as

$${δ}_{j}^{6} = 1$$

for all j∈J, and

$${δ}_{j}^{6} = 0$$

for all j∉J.

It is noted that the first norm ∥⋅∥₁, the second norm ∥⋅∥₂, the third norm ∥⋅∥₃, the fourth norm ∥⋅∥₄, the fifth norm ∥⋅∥₅ and the sixth norm ∥⋅∥₆ need not be different. In some implementations, some or all of the first norm ∥⋅∥₁, second norm ∥⋅∥₂, third norm ∥⋅∥₃, fourth norm ∥⋅∥₄, fifth norm ∥⋅∥₅ and sixth norm ∥⋅∥₆ are the same norm.

As stated, the cost function (229) is based on the first terms A₁(α_{T}) from EQ. 7, the second term A₂(α_{V}, α_{T}) from EQ. 9 and the third term A₃(α_{V}, α_{T}) from EQ. 13. In some embodiments, the cost function (229) is further based on one or more of the fourth term A₄(α_{V},α_{T}) from EQ. 18, the fifth term A₅(α_{T}) from EQ. 22 and the sixth term A₆ (α_{V}) from EQ. 24. In one or more embodiments, the cost function (229), denoted by L, is defined by:

$$L ( {α}_{V} , {α}_{T} ) = G ( {A}_{1} ( {α}_{T} ) , {A}_{2} ( {α}_{V} , {α}_{T} ) , {A}_{3} ( {α}_{V} , {α}_{T} ) , {A}_{4} ( {α}_{V} , {α}_{T} ) , {A}_{5} ( {α}_{T} ) , {A}_{6} ( {α}_{V} ) ) , \qquad EQ . 26$$

where G:( [symbol] )^{5+D}→ [symbol] as a function of 5+D variables, that is increasing with respect to each of its first two variables, increasing with at least one of its third to its (2+D)^{th} variables, and non-decreasing with respect to the other variables. Furthermore, the function G as such that G (0, . . . , 0)=0. Let i∈[1,2+D] be an integer and i∈( [symbol] )^{5+D} be the vector with the i^{th} component equal to 1, and of the other components equal to 0. A function, g:( [symbol] )^{5+D}→ [symbol] is said to be increasing with respect to its i^{th} variable if, for any vector u∈( [symbol] )^{5+D} and any real number ϵ>0, g(u+ϵ\vec{i})>g(u). A function, g:( [symbol] )^{5+D}→ [symbol] is said to be non-decreasing with respect to its i^{th} variable if, for any vector u∈( [symbol] )^{5+D} and any real number ϵ>0, g(u+ϵ\vec{i})≤g(u).

In one or more embodiments, the cost function is written as a linear combination of the first terms A₁(α_{T}) from EQ. 7, the second term A₂(α_{V}, α_{T}) from EQ. 9, the third term A₃(α_{V}, α_{T}) from EQ. 13, the fourth term A₄(α_{V}, α_{T}) from EQ 18, the fifth term A₅(α_{T}) from EQ. 22 and the sixth term A₆(α_{V}) from EQ. 24:

$$L ( {α}_{V} , {α}_{T} ) = {λ}_{1} {A}_{1} ( {α}_{T} ) , {λ}_{2} {A}_{2} ( {α}_{V} , {α}_{T} ) + < {λ}_{3} , {A}_{3} ( {α}_{V} , {α}_{T} ) > + {λ}_{4} {A}_{4} ( {α}_{V} , {α}_{T} ) + {A}_{5} ( {α}_{T} ) + {λ}_{6} {A}_{6} ( {α}_{V} ) , \qquad EQ . 27$$

where the weights λ₁, λ₂, λ₄, λ₅ and λ₆ are real numbers such that λ₁>0, λ₂>0, λ₄≥0, λ₅≥0 and λ₆>0. The weight vector λ₃ is real-valued vector with D non-negative components,

$${λ}_{3}^{k} ,$$

that are not all zeros, meaning that

$${λ}_{3}^{k} \geq 0 ,$$

for all 1≤k≤D, and

$${\sum }_{k = 1}^{k = D} {λ}_{3}^{k} > 0.$$

The weights

$${λ}_{3}^{k}$$

scale the components of A₃(α_{V}, α_{T}) which are based on the derivatives of EQ. 4 in each of the D dimensions of the region of interest. The term <λ₃, A₃(α_{V}, α_{T})> denotes a dot product between the D-dimensional weight vector λ₃, and the D-dimensional third term A₃(α_{V}, αd). The weights of the cost function L in EQ. 27, λ₁, λ₂,

$${λ}_{3}^{k} ,$$

for 1≤k≤D, λ₄, λ₅ and λ₆ can be defined in many ways. In some implementations, the weights λ₁, λ₂,

$${λ}_{3}^{k} ,$$

for 1≤k≤D, λ₄, λ₅ and λ₆ are selected manually. In some implementations, the weights λ₁, λ₂,

$${λ}_{3}^{k} ,$$

for 1≤k≤D, λ₄, λ₅ and λ₆ are all set to 1, meaning that the terms of the cost function in EQ. 27 are equally weighted. In other implementations the weights, λ₄, λ₅ and λ₆ are set to 0, meaning that the cost function L in EQ. 27 is only based on the travel-time mismatches, the travel times equation (227) and one or more derivatives of the travel times equation (227). In some implementations one or more of the weights λ₁, λ₂,

$${λ}_{3}^{k} ,$$

for 1≤k≤D, λ₄, λ₅ and λ₆ are determined using a grid search, as described later in this disclosure.

An example embodiment for the cost function in EQ. 27 is described herein. The training source locations (231) are selected to be the seismic source locations from the seismic traces of the training seismic dataset, meaning that nₛ=m, and Sᵢ=X_{s,i}, for each 1≤i≤nₛ. The weights are selected as

$${λ}_{1} = {λ}_{2} = {λ}_{3}^{k} = {λ}_{4} = 1 ,$$

for 1≤k≤D, and λ₅=λ₆=0. The In this specific embodiment, the term A₁(α_{T}) is given by EQ. 8, the term A₂(α_{V}, α_{T}) is given by EQ. 10, the term A₃(α_{V}, α_{T}) is given by EQ. 14 and the term A₄(α_{V}, α_{T}) is given by EQ. 20. The weights used in EQs. 8, 10, 14 and 20 are selected as

$$δ {}_{i , j}^{1} = 1 , δ {}_{i , j}^{1} = 1 , δ {}_{i , j}^{1} = 1 and δ {}_{i , j}^{1} = 1$$

for all applicable i and j. In this specific embodiment. EQ. 26 reads:

$$L ( {α}_{V} , {α}_{T} ) = \frac{1}{\sum {}_{j = 1}^{i = {n}_{s}} {m}_{i}} \sum {}_{i = 1}^{i = {n}_{s}} \sum {}_{j = 1}^{j = {m}_{i}} {\vert {T}_{obs} ( {X}_{s , i} , {R}_{i , j} ) - {N}_{T} ( {α}_{T} , {X}_{s , i} , {R}_{i , j} ) \vert}^{2} + \frac{1}{{n}_{s} {n}_{p}} \sum {}_{i = 1}^{i = {n}_{s}} \sum {}_{j = 1}^{j = {n}_{p}} {\vert F ( {X}_{j} , {N}_{V} ( {α}_{V} , {X}_{j} ) , {N}_{T} ( {α}_{T} , {X}_{s , i} , {X}_{j} ) ) \vert}^{2} + \frac{1}{{n}_{s} {n}_{p}} \sum {}_{k = 1}^{k = D} \sum {}_{i = 1}^{i = {n}_{s}} \sum {}_{j = 1}^{j = {n}_{p}} {\vert {\partial }_{k} f ( {α}_{V} , {α}_{T} , {X}_{s , i} , {X}_{j} ) \vert}^{2} + \frac{1}{{n}_{s}} \sum {}_{i = 1}^{i = {n}_{s}} {\vert {N}_{T} ( {α}_{T} , {X}_{s , i} , {X}_{s , i} ) \vert}^{2} . \qquad EQ . 28$$

In implementations where the travel times equation is the Eikonal equation in EQ. 5, EQ. 28 becomes:

$$L ( {α}_{V} , {α}_{T} ) = \frac{1}{\sum {}_{j = 1}^{i = {n}_{s}} {m}_{i}} \sum {}_{i = 1}^{i = {n}_{s}} \sum {}_{j = 1}^{j = {m}_{i}} {\vert {T}_{obs} ( {X}_{s , i} , {R}_{i , j} ) - {N}_{T} ( {α}_{T} , {X}_{s , i} , {R}_{i , j} ) \vert}^{2} + \frac{1}{{n}_{s} {n}_{p}} \sum {}_{i = 1}^{i = {n}_{s}} \sum {}_{j = 1}^{j = {n}_{p}} {\vert H ( {X}_{i} , {N}_{V} ( {α}_{V} , {X}_{j} ) , ∇ {N}_{T} ( {α}_{T} , {X}_{s , i} , {X}_{j} ) ) \vert}^{2} + \frac{1}{{n}_{s} {n}_{p}} \sum {}_{k = 1}^{k = D} \sum {}_{i = 1}^{i = {n}_{s}} \sum {}_{j = 1}^{j = {n}_{p}} {\vert {\partial }_{k} f ( {α}_{V} , {α}_{T} , {X}_{s , i} , {X}_{j} ) \vert}^{2} + \frac{1}{{n}_{s}} \sum {}_{i = 1}^{i = {n}_{s}} {\vert {N}_{T} ( {α}_{T} , {X}_{s , i} , {X}_{s , i} ) \vert}^{2} . \qquad EQ . 29$$

The cost function (229), L, depends on the velocity parameters (215) α_{V} and the travel time parameters (221) α_{T}.

The cost L(α_{V}, α_{T}) is nonnegative. Selecting velocity parameters (215) α_{V} and travel time parameters (221) α_{T} such that L(α_{V}, α_{T})=0 would imply, at least, that the travel time mismatches are all zero, the approximate velocities N_{V}(α_{V}, Xⱼ) and travel times N_{T}(α_{T}, X_{s,i}, Xⱼ) satisfy the travel times equation (227), and one or more derivatives of the travel times equation (227) are all zeros, for i=1, . . . nₛ, for j=1 . . . , nₚ. Selecting velocity parameters (215) α_{V} and travel time parameters (221) α_{T} such that L(α_{V}, α_{T})=0 is not assumed to be possible. In this disclosure, trained velocity parameters (241), denoted as \hat{α}_{V}, and trained travel time parameters (243), denoted as \hat{α}_{T}, are selected such that the cost L(\hat{α}_{V}, \hat{α}_{T}) is optimally small. The trained velocity parameters (241) \hat{α}_{V} and trained travel tune parameters (243) \hat{α}_{T} are determined by operating an optimizer (239). The optimizer (239) seeks a solution

$$( α {}_{V}^{*} , α {}_{T}^{*} )$$

to the following minimization problem:

$$find ( α {}_{V}^{*} , α {}_{T}^{*} ) ∈ {ℝ}^{{M}_{V}} \times {ℝ}^{{M}_{T}} such that for all ( {α}_{V} , {α}_{T} ) ∈ {ℝ}^{{M}_{V}} \times {ℝ}^{{M}_{T}} , L ( α {}_{V}^{*} , α {}_{T}^{*} ) \leq L ( {α}_{V} , {α}_{T} ) . \qquad EQ . 30$$

Determining (\hat{α}_{V}, \hat{α}_{T}) using the optimizer (239) is called training the trainable velocity network (213) and the trainable travel time network (219). The parameters (\hat{α}_{V}, \hat{α}_{T}) are called trained parameters. The parameters \hat{α}_{V} are called trained velocity parameters. The parameters \hat{α}_{T} are called trained travel time parameters.

Finding parameters

$$( α {}_{V}^{*} , α {}_{T}^{*} )$$

that satisfy EQ. 30 is only possible in rare cases. For instance, finding

$$( α {}_{V}^{*} , α {}_{T}^{*} )$$

that satisfy EQ. 30 is only possible in cases where the equation ∇_{α}L (α_{V}, α_{T})=0 can be solved for (α_{V}, α_{T}), and it can be shown that at least one solution, denoted by

$$( α {}_{V}^{*} , α {}_{T}^{*} ) ,$$

satisfying

$${∇}_{α} L ( α {}_{V}^{*} , α {}_{T}^{*} ) = 0 ,$$

also satisfies EQ. 30. The notation ∇_{α}L stands for the gradient of L with respect to the variables (α_{V}, α_{T}). In such scenarios, the trained parameters (\hat{α}_{V}, \hat{α}_{T}) are solutions

$$( α {}_{V}^{*} , α {}_{T}^{*} )$$

to EQ. 30 and the optimizer (239) is defined as a computing ∇_{α}L (α_{V}, α_{T}), solving the equation ∇_{α}L (α_{V}, α_{T})=0, and selecting

$$( α {}_{V}^{*} , α {}_{T}^{*} )$$

satisfying EQ. 30, among the solutions to the equation ∇_{α}L (α_{V}, α_{T})=0.

Generally, the optimization problem in EQ. 30 is solved in an approximate sense, by iterating an algorithm, called the optimizer (239), until a certain stopping criterion is met. Given initial parameters (α_{V}, α_{T})⁰∈ [symbol] × [symbol] , the optimizer (239) produces a recurrent sequence, indexed by an integer iteration number q≥1, of parameters (α_{V}, α_{T})^{q}∈ [symbol] × [symbol] such that (α_{V}, α_{T})^{q} only depends on the values of the parameters (α_{V}, α_{T})^{s}, for s<q. In one or more embodiments, the initial parameters (α_{V}, α_{T})⁰ are defined randomly. In one or more embodiments, the optimizer (239) is defined such that the parameters (α_{V}, α_{T})^{q}, at each iteration q, only depend on the values at the previous iteration, (α_{V}, α_{T})^{q-1}. Intuitively, the goal of the optimizer (239) is that the cost function L, applied to one of the terms of the sequence (α_{V}, α_{T})^{q} at an iteration q*, namely, L(α_{V}, α_{T})^{q*}) be as small as possible. In one or more embodiments, the optimizer (239) is defined such that the sequence L(α_{V}, α_{T})^{q}) is a decreasing sequence and then, iterating the optimizer (239) always produces parameters (α_{V}, α_{T})^{q} associated with a smaller cost, L(α_{V}, α_{T})^{q}), than the previous cost. L(α_{V}, α_{T})^{q-1}). The optimizer (239) runs for a certain number of iterations, Q≥1, called the maximum iteration number. In one or more embodiments, the maximum iteration number Q may be pre-defined and the stopping criterion for the optimizer (239) may be that the iteration number q reaches the pre-defined maximum iteration number Q. The stopping criterion for the optimizer (239) can be defined in many other ways. In some embodiments, the stopping criterion consists of noting that the distance |L(α_{V}, α_{T})^{q})−L((α_{V}, α_{T})^{q-1})| is less than a predefined convergence threshold for a certain q≥1. If a stopping criterion is met at a certain iteration, the optimizer (239) is said to have converged, and the iterative process stops.

Regardless of the definition of the stopping criterion, the maximum iteration number is reached when the stopping criterion is met, and is denoted as Q. After the optimizer (239) has converged, the trained parameters (\hat{α}_{V}, \hat{α}_{T}) can be defined in many ways. In some embodiments, the trained parameters are defined as (\hat{α}_{V}, \hat{α}_{T})=(α_{V}, α_{T})^{Q}, that is, the last value obtained by the optimizer (239) when the stopping criterion is met. In other embodiments, the trained parameters are defined as (\hat{α}_{V}, \hat{α}_{T})=(α_{V}, α_{T})^{Q*}, for some integer q* such that 0≤q*≤Q, that minimizes the cost in the following sense: for all q such that 0≤q≤Q. L(α_{V}, α_{T})^{q*})≤L((α_{V}, α_{T})_{q}).

In one or more embodiments, the optimizer (239) is a gradient descent method. While a full review of the gradient descent method exceeds the scope of this disclosure, a brief summary is provided herein. In a gradient descent method, the gradient ∇_{α}L(α_{V}, α_{T})^{q} of the cost function (229) with respect to α_{V} and α_{T}, is computed at each iteration q and evaluated at (α_{V}, α_{T})^{q}. The process of computing the gradient is known as “backpropagation.”. The gradient indicates the direction of change for the parameters values (α_{V}, α_{T})^{q}, that results in the greatest change to the cost function L. Because the gradient is local to the values (α_{V}, α_{T})^{q} at iteration q, the parameters values (α_{V}, α_{T})^{q} are typically updated by a “step”, denoted as γ^{q}, in the opposite direction indicated by the gradient. The step size is often referred to as the “learning rate” and need not remain fixed during the training process. Additionally, the step size and direction at an iteration q may be informed by parameter values and respective gradients at previous iterations, namely, the parameter values (α_{V}, α_{T})^{s} and/or the respective gradients ∇_{α}L(α_{V}, α_{T})^{s}, for s<q. Such methods, for determining the step direction based on parameter values and respective gradients at previous iterations, are usually referred to as “momentum” based methods. The parameters α_{V} and α_{T} are the updated as (α_{V}, α_{T})^{q}=(α_{V}, α_{T})^{q-1}−γ^{q}.

In one or more embodiments, the cost function L is given by EQ. 27, one or more weights within the weights λ₁, λ₂,

$${λ}_{3}^{k} ,$$

for 1≤k≤D, λ₄, λ₅ and λ₆ are determined using a grid search. The one or more weights within the weights λ₁, λ₂,

$${λ}_{3}^{k} ,$$

for 1≤k≤D, λ₄, λ₅ and λ₆ to be determined using a grid search are denoted as Λ. To perform a grid search for Λ, a certain integer number N of values of Λ are selected, denoted Λⁱ, for 1≤i≤N. For each Λⁱ, a tentative cost function Lⁱ is formed given by EQ. 27 with weights αⁱ, and the optimizer (239) is run to optimize Lⁱ. For each tentative cost function Lⁱ, the optimizer (239) returns preliminary trained velocity parameters

$${\hat{α}}_{V}^{i}$$

and preliminary trained travel time parameters

$${\hat{α}}_{T}^{i} ,$$

for 1≤i≤N. The trained velocity parameters and travel time parameters, (\hat{α}_{V}, \hat{α}_{T}), are selected as the preliminary trained velocity parameters and preliminary trained travel time parameters,

$$( {\hat{α}}_{V}^{{i}^{*}} , {\hat{α}}_{T}^{{i}^{*}} ) ,$$

for the integer i* such that for all 1≤i≤N,

$${L}^{{i}^{*}} ( {\hat{α}}_{V}^{{i}^{*}} , {\hat{α}}_{T}^{{i}^{*}} ) \leq {L}^{i} ( {\hat{α}}_{V}^{i} , {\hat{α}}_{T}^{i} ) .$$

The weights determined by the grid search are Λ^{i′} and a final cost function is L^{i′}, that is, the cost function L with weights Λ^{i′} in EQ. 27.

A trained velocity network is obtained by using, in the trainable velocity network (213), the trained velocity parameters (241) \hat{α}_{V} in lieu of the velocity parameters (215) α_{V}. A trained travel time network is obtained by using, in the trainable travel time network (219), the trained travel time parameters (243) \hat{α}_{T} in lieu of the travel time parameters (221) α_{T}. In some embodiments, the trained velocity network is interpreted as approximating the velocity function in the travel times formula in EQ. 1. In some embodiments, the trained travel time network is interpreted as approximating the travel time function in the travel times formula in EQ. 1.

In one or more embodiments, the training seismic dataset is not the whole seismic dataset (209) and the trained parameters (\hat{α}_{V}, \hat{α}_{T}) are validated using the testing seismic traces. The testing seismic dataset includes a certain number n of testing seismic traces, [symbol] , for 1≤i≤n. Each testing seismic trace [symbol] includes a seismic source location,

$${S}_{i}^{test}$$

and a receiver location,

$${R}_{i}^{test} .$$

For each testing seismic trace [symbol] , an observed travel time,

$${T}_{obs} ( {S}_{i}^{test} , {R}_{i}^{test} ) ,$$

has been determined as part of the observed travel times (211). The trained parameters (\hat{α}_{V}, \hat{α}_{T}) are validated by computing a metric for the testing seismic traces, the metric comparing each observed travel time

$${T}_{obs} ( {S}_{i}^{test} , {R}_{i}^{test} )$$

with a corresponding output from the trained travel time network,

$${N}_{T} ( {\hat{α}}_{T} , {S}_{i}^{test} , {R}_{i}^{test} ) .$$

Examples of metrics that may be used to validate the trained parameters (\hat{α}_{V}, \hat{α}_{T}) include any scoring or comparison function known in the art, including but not limited to: mean square error (MSE), root mean square error (RMSE), and coefficient of determination (R²). These comparison functions are defined as

$$MSE = \frac{1}{n} {\sum }_{i = 1}^{i = n} {\vert {N}_{T} ( {\hat{α}}_{T} , {S}_{i}^{test} , {R}_{i}^{test} ) - {T}_{o bs} ( {S}_{i}^{test} , {R}_{i}^{test} ) \vert}^{2} , \qquad EQ . 31$$

$$RMSE = \sqrt{\frac{1}{n} {\sum }_{i = 1}^{i = n} {\vert {N}_{T} ( {\hat{α}}_{T} , {S}_{i}^{test} , {R}_{i}^{test} ) - {T}_{o bs} ( {S}_{i}^{test} , {R}_{i}^{test} ) \vert}^{2}} , \qquad EQ . 32$$

$${R}^{2} = 1 - \frac{{\sum }_{i = 1}^{i = n} {\vert {N}_{T} ( {\hat{α}}_{T} , {S}_{i}^{test} , {R}_{i}^{test} ) - {T}_{o bs} ( {S}_{i}^{test} , {R}_{i}^{test} ) \vert}^{2}}{{\sum }_{i = 1}^{i = n} {\vert {T}_{o bs} ( {S}_{i}^{test} , {R}_{i}^{test} ) - \overline{{T}_{o bs}} \vert}^{2}} . \qquad EQ . 33$$

In EQ. 33, T̅_̅{̅o̅b̅s̅}̅ is the average testing observed travel time, which means:

$$\overline{{T}_{o bs}} = \frac{1}{n} {\sum }_{i = 1}^{i = n} \overline{{T}_{o bs}} .$$

Given a set of evaluation locations in the region of interest, denoted as

$${X}_{j}^{P} ,$$

for 1≤j≤nᵢ, an evaluation velocity model is formed by inputting the evaluation locations to the trained velocity network, and recording the results. That is, the evaluation velocity model is a set including values

$${N}_{V} ( {\hat{α}}_{V} , {X}_{j}^{P} ) ,$$

for 1≤j≤nₗ. In some embodiments, the evaluation velocity model is the set composed of pairs

$$( {X}_{j}^{P} , {N}_{V} ( {\hat{α}}_{V} , {X}_{j}^{P} ) ) .$$

In some embodiments, the evaluation velocity model represents a velocity of seismic waves in the region of interest. Regardless of the dimensionality of the evaluation velocity model, the evaluation velocity model may be displayed as one or more two-dimensional representations. If the region of interest is two-dimensional, the evaluation velocity model is also two-dimensional and therefore is a two-dimensional representation of itself. If the region of interest is three-dimensional the evaluation velocity model is either two-dimensional or three-dimensional, depending on the choice of the evaluation locations

$${X}_{j}^{P}$$

If the evaluation velocity model is three-dimensional, a two-dimensional representation of the evaluation velocity model may be a projection of the evaluation velocity model on a two-dimensional surface, such as a cross-section or a horizontal slice.

In one or more embodiments, continuing with FIG. 2, an image (245) of the evaluation velocity model is extracted. The image (245) may be of various types. In some implementations, the image (245) is a two-dimensional representation of the evaluation velocity model on a screen, or a two-dimensional screen capture. In other implementations, the image (245) is a file, stored on a disk, a tape or any computer readable storage medium known in the art. In further implementations, the image (245) is a printed two-dimensional representation of the evaluation velocity model on a physical support, such as piece of paper, plastic or metal. The image (245) may be analyzed for various purposes, including, but not limited to, performing quality control of the trained velocity network and defining a property of the region of interest. In some embodiments, performing quality control of the trained velocity network includes comparing the evaluation velocity model with a control velocity model. The control velocity model may be a legacy velocity model. The legacy velocity model is a velocity field of the region of interest obtained by a conventional velocity analysis method that does not include using the trained velocity network. Examples of conventional velocity analysis methods include a residual moveout (RMO) tomography and a full waveform inversion (FWI). If the seismic dataset (209) is obtained using the simulator (207), the control velocity model may be a synthetic velocity model, used to simulate the seismic traces of the seismic dataset (209). Properties of the region of interest include rock properties, such as a porosity, resistivity and permeability. Properties of the region of interest further include a stratigraphy of the subsurface. It is emphasized that the examples of the image (245), quality control and physical properties of the region of interest are given only as examples and should be considered non-limiting. One with ordinary skill in the art will acknowledge that other forms of the image (245), quality control and physical properties of the region of interest may be used in the system in FIG. 2 without departing from the scope of this disclosure.

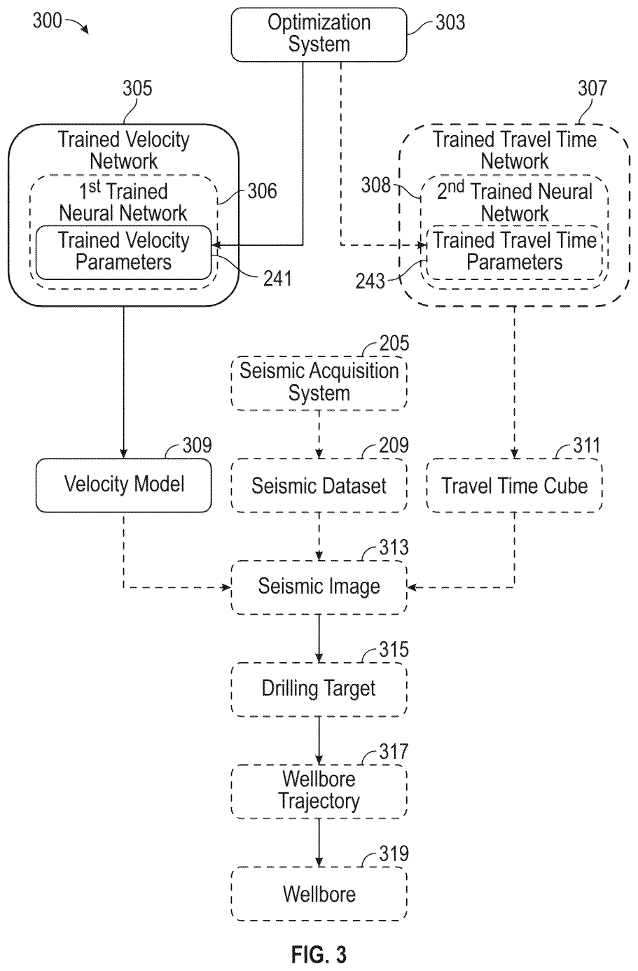

FIG. 3 depicts a system (300) for using a trained velocity network (305) to produce a velocity model, in accordance with one or more embodiments. The trained velocity network (305) is obtained using an optimization system (303). Examples of the optimization system (303) include, but are not limited to, the system (200) depicted in FIG. 2. The optimization system (303) includes the cost function (229). The cost function (229) is based on, at least, the travel times equation (227), one or more derivatives of the travel times equation (227), and one or more travel time mismatches. A travel time mismatch is defined as a difference between an observed travel time within the observed travel times (211) and a travel time value output by the trainable travel time network (219). The optimization system (303) is used to compute the trained velocity parameters (241) \hat{α}_{V}, using the optimizer (239) to minimize the cost function (229). The trained velocity network (305) is obtained by replacing, in the trainable velocity network (213), the velocity parameters (215) with, the trained velocity parameters (241). In some embodiments, the trainable velocity network (213) includes, or is, the first neural network (217) and as a result, the trained velocity network (305) includes, or is, a first trained neural network (306). The first trained neural network (306) is obtained by replacing, in the first neural network (217), the velocity parameters (215) with the trained velocity parameters (241) \hat{α}_{V}. An output to the trained velocity network (305), for a location X within the region of interest, is then denoted as N_{V}(\hat{α}_{V}, X).

A first plurality of prediction locations is formed as a set of

$${n}_{w}^{V}$$

distinct points, denoted as

$${W}_{i}^{V} ,$$

for

$$1 \leq i \leq {n}_{w}^{V} ,$$

that form a first discretization of the region of interest. In one of more embodiments, the first discretization is regular. Examples of a regular discretization are described herein. If D=3, the first discretization may be defined as regular if the prediction locations

$${W}_{i}^{V}$$

are vertices of a first plurality of parallelepipeds discretizing the region of interest, the parallelepipeds having a same height, depth and width. If D=2, the first discretization may be defined as regular if the prediction locations

$${W}_{i}^{V}$$

are vertices of a first plurality or rectangles discretizing the region of interest, the rectangles having a same depth and width. For any point,

$${W}_{i}^{V}$$

within the first plurality of prediction locations, a velocity may be computed as an output to the trained velocity network (305) at point Wᵢ, namely,

$${N}_{V} ( {\hat{α}}_{V} , {W}_{i}^{V} ) .$$

A velocity model (309) is determined for the region of interest. The velocity model includes a plurality of velocity values, Vᵢ, for

$$1 \leq i \leq {n}_{w}^{V} .$$

Each velocity value, Vᵢ, is defined as an output to the trained velocity network (305) associated with a point

$${W}_{i}^{V} ,$$

which means:

$${V}_{i} = {N}_{V} ( {\hat{α}}_{V} , {W}_{i}^{V} ) ,$$

for

$$1 \leq i \leq {n}_{w}^{V} .$$

In some implementations, the velocity model (309) is defined as a set of pairs

$$( {W}_{i}^{V} , {V}_{i} ) ,$$

for

$$1 \leq i \leq {n}_{w}^{V} .$$

In some implementations, the velocity model is composed of the velocity values Vᵢ and a correspondence mapping between each velocity value Vᵢ and the point

$${W}_{i}^{V}$$

associated with the velocity value Vᵢ, for

$$1 \leq i \leq {n}_{w}^{V} ,$$

In some embodiments, the first discretization is regular and given a vertical line of points

$${W}_{{i}_{j}}^{V} ,$$

for 1≥

$$j \leq {n}_{{w}_{i}}^{V} ,$$

for some integer

$${n}_{{w}_{i}}^{V} ,$$

the set of velocity values

$$\{ {V}_{ij} , 1 \leq j \leq {n}_{{w}_{i}}^{V} )$$

is said to form a velocity trace of the velocity model (309). Therefore, in some embodiments, the velocity model (309) includes, or is composed of, a plurality of velocity traces. In such embodiments, the velocity model (309) may be represented as a D-dimensional table of

$${n}_{w}^{V}$$

elements, each element of the table containing one of the velocity values Vᵢ, for

$$1 \leq i \leq {n}_{w}^{V}$$

and mapped to the point

$${W}_{i}^{V}$$

associated with Vᵢ.

As stated, in one or more embodiments, the seismic dataset (209) is acquired by a seismic acquisition system (205). Examples of a seismic acquisition system include the seismic acquisition system (100) in FIG. 1. The seismic dataset (209) includes one or more seismic traces. Each seismic trace within the seismic dataset (209) includes a seismic source location and a seismic receiver location. For each seismic trace within the seismic dataset (209), the seismic source location of the trace is a location of the seismic source that was fired to acquire the seismic trace. For a seismic trace acquired by the seismic acquisition system (205), the seismic receiver location of the seismic trace is a location of a receiver that recorded the seismic trace.

A seismic image (313) of the region of interest is determined, based on the seismic dataset (209) and the velocity model (309). The seismic image (313) may represent a region of interest. The seismic image (313) may be two-dimensional or three-dimensional. In some implementation, the last dimension of the seismic image represents a depth. In other implementations, the last dimension of the seismic image represents time. In some implementations, the seismic image (313) is computed using an imaging algorithm that receives the seismic dataset (209) and the velocity model (309) as inputs. In some implementations, the imaging algorithm is a migration algorithm.

One with ordinary skill in the art will recognize that a full discussion of every type of migration applicable to computing the seismic image (313) is not possible nor required to describe the systems and methods in this disclosure. However, a brief discussion and summary of a Kirchhoff migration, a reverse-time migration (RTM) and a beam migration, are provided herein. A Kirchhoff migration algorithm is designed to find all the possible reflecting locations, within the subsurface, where reflected seismic waves recorded in a seismic trace might have reflected. The possible reflecting locations are based on the times at which the reflected seismic waves are recorded on the seismic trace. The possible reflecting locations where reflected seismic waves might have reflected may indicate positions of seismic reflectors in the subsurface. A beam migration algorithm is designed to find all the possible reflecting locations, within the subsurface, from where the reflected seismic waves recorded in a set of a predefined number of seismic traces from adjacent seismic receivers might have reflected. The possible reflecting locations are based on the times at which the reflected seismic waves are recorded on each seismic trace within the set of seismic traces from adjacent seismic receivers. The possible reflecting locations where reflected seismic waves might have reflected may indicate locations of seismic reflectors in the subsurface. By including a set of seismic traces from adjacent seismic receivers as input, beam migration receives information of a delay with which the reflected seismic waves arrive at each adjacent seismic receiver The delay may indicate an inclination of the seismic reflectors in the subsurface. A RTM algorithm includes simulating the propagation of a downgoing wavefield through the subsurface from the seismic source locations using a wave equation, and simulating the backpropagation in time, of an upgoing wavefield recorded at receiver locations, though the subsurface using a wave equation. Then, an imaging condition may indicate locations of seismic reflectors within the subsurface by matching locations where the downgoing wavefield meets the upgoing wavefield. It is emphasized that the example migrations described herein are given only as examples and should be considered non-limiting. Other types of migration or imaging algorithms may be used to determine the seismic image (313) without departing from the scope of this disclosure.

In some embodiments, the seismic image (313) is determined using a first imaging algorithm that makes use of seismic wave travel times. In these embodiments, a number

$${n}_{w}^{S} > 1$$

of prediction source locations are selected and denoted as

$${W}_{S , i}^{T} ,$$

for

$$1 \leq i \leq {n}_{w}^{S} .$$

The prediction source locations may be defined in many ways, in a similar fashion to the training source locations (231) are defined in the description of FIG. 2. In some implementations, the prediction source locations are located on a line pertaining to the region of interest. In some implementations, the prediction source locations discretize a portion of the boundary of the region of interest. In some implementations, the boundary of the region of interest includes a surface of the Earth and the prediction source locations discretize the surface. In some implementations, the prediction source locations are located on a vertical line originating from the surface. A second plurality of prediction locations is formed as a set of

$${n}_{w}^{T}$$

distinct points, denoted as

$${W}_{i}^{T} ,$$

for

$$1 \leq i \leq {n}_{w}^{T} ,$$

that form a second discretization of the region of interest. In some implementations, the second plurality of prediction locations is the first plurality of prediction locations. In one or more embodiments, the second discretization is regular. The first imaging algorithm makes use of seismic travel times between the prediction source locations and the prediction locations. The seismic travel times include, for each prediction source location

$${W}_{S , i}^{T} ,$$

and each prediction location

$${W}_{j}^{T} ,$$

a seismic travel time value T_{i,j} between the prediction source location

$${W}_{S , i}^{T}$$

and the prediction location

$${W}_{j}^{T} ,$$

for

$$1 \leq i \leq {n}_{w}^{S} ,$$

for

$$1 \leq j \leq {n}_{w}^{T} .$$

The seismic travel times may be computed in many ways. In the system (300), a trained travel time network (307) is obtained using the optimization system (303). In some embodiments, such as the system described in FIG. 2, the optimization system (303) is used to compute the trained travel time parameters (243) \hat{α}_{T}, in addition to computing the trained velocity parameters (241) \hat{α}_{V}. In some embodiments, such as the system described in FIG. 2, the trained travel time parameters (243) \hat{α}_{T}, are computed using the optimizer (239) that seeks to minimize the cost function (229). The trained travel time network (307) is obtained by replacing, in the trainable travel time network (219), the travel time parameters (221) with the trained travel time parameters (243) \hat{α}_{T}. In some embodiments, the trainable travel time network (219) includes the second neural network (223) and as a result, the trained travel time network (307) includes a second trained neural network (308). The second trained neural network (308) is obtained by replacing, in the second neural network (223), the travel time parameters (221) with the trained travel time parameters (243) \hat{α}_{T}. An output to the trained travel the network (307), for a source location S within the region of interest and a prediction location X within the region of interest, is then denoted as N_{T}(\hat{α}_{T}, S, X).

In the system (300), the seismic travel times are calculated as outputs from the trained travel time network (307). For each prediction source location

$${W}_{S , i}^{T} ,$$

and each prediction location

$${W}_{j}^{T} ,$$

the seismic travel time value T_{i,j}, between the prediction source location

$${W}_{S , i}^{T}$$

and the prediction location

$${W}_{j}^{T} ,$$

is defined as

$${T}_{i , j} = {N}_{T} ( {\hat{α}}_{T} , {W}_{S , i}^{T} , {W}_{j}^{T} ) ,$$

for

$$1 \leq i \leq {n}_{w}^{S} ,$$

for

$$1 \leq j \leq {n}_{w}^{T} .$$

A travel time cube (311) is formed for the region of interest. The travel time cube (311) includes the seismic travel times T_{i,j} for

$$1 \leq i \leq {n}_{w}^{S} ,$$

for

$$1 \leq j \leq {n}_{w}^{T} .$$

In some implementations, the travel time cube (311) is defined as a set of the triplets

$$( {W}_{S , i}^{T} , {W}_{j}^{T} , {T}_{i , j} ) ,$$

for

$$1 \leq i \leq {n}_{W}^{S} ,$$

for

$$1 \leq j \leq {n}_{W}^{T} .$$

In some implementations, the travel time cube (311) is composed of the travel time values T_{i,j} and a correspondence mapping between each travel time values T_{i,j} and the pair

$$( {W}_{S , i}^{T} , {W}_{j}^{T} )$$

associated with the travel time values T_{i,j}, for

$$1 \leq i \leq {n}_{W}^{S} ,$$

for

$$1 \leq j \leq {n}_{W}^{T} .$$

In some embodiments, the second discretization is regular and the travel time cube (311) is represented as a (D+1)-dimensional table of

$${n}_{W}^{S} \times {n}_{W}^{T}$$

elements, each element of the table containing one of the travel time values T_{i,j}, for

$$1 \leq i \leq {n}_{W}^{S} .$$

for

$$1 \leq j \leq {n}_{W}^{T}$$

and mapped to the pair

$$( {W}_{S , i}^{T} , {W}_{j}^{T} )$$

associated with T_{i,j}. The travel time cube (311) is then used by the first imaging algorithm to determine the seismic image (313).

In one or more embodiments, the seismic image (313) is used to identify a drilling target (315). The drilling target (315) may be of many types. Examples of a drilling target include a potential reservoir of a natural resource, an injection site for a material into the subsurface and an extraction site of a material from the subsurface. Examples of potential reservoirs of a natural resource include a potential hydrocarbon reservoir. Examples of injection sites for a material into the subsurface include a water injection site, where water is to be injected in order to alter a pressure of the subsurface. Examples of extraction sites of a material from the subsurface include a region in the subsurface where rock is to be extracted in order to be analyzed. The drilling target (315) is identified using, at least, an interpretation workstation that allows geoscientists to analyze the seismic image (313), received by the interpretation workstation. In some embodiments, the geoscientists form, or are part of, an exploration team. Examples of geoscientists include, but are not limited to, geologists, geophysicists and interpreters.

In order to analyze the seismic image (313), the geoscientists may perform various interpretation tasks, such as such as interpreting key geological horizons that delimit stratigraphic layers, boundaries, and structural features of the subsurface. Examples of interpretation tasks further include computing seismic attributes of the seismic image (313), such as a frequency, a gradient, an envelope, and a coherency. Results of the interpretation tasks enable the geoscientists to locate the drilling target (315). In some embodiments, the geoscientists produce one or more of a map of the drilling target (315), properties of the drilling target (315) and properties of the region of interest. Examples of properties of the drilling target (315) include, but are not limited to, a distribution of a material in a vicinity of the drilling target (315), a rock property for a rock composing the drilling target (315), a volume of the material in the vicinity of the drilling target (315), a performance of the drilling target (315), and a risk assessment associated with perforating the drilling target (315). Properties of the region of interest include rock properties, such as a porosity, resistivity and permeability. Properties of the region of interest further include a stratigraphy of the subsurface.

In one or more embodiments, a decision is made to drill a wellbore (319) perforating the drilling target (315). For this purpose, a wellbore trajectory (317) is planned, guided by the drilling target (315). The wellbore trajectory (317) extends from the surface of the Earth to the drilling target (315). In some embodiments, the wellbore trajectory (317) is constrained by surface limitations, such as a hazardous terrain, availability and configuration of drilling equipment, and layout of natural or man-made islands. Additionally, the locations of potential or preexisting drilling sites may be considered. In one or more embodiments, the decision drill a wellbore (319) is taken by stakeholders in an industry or a governmental entity. Examples of stakeholders include, but are not limited to, geoscientists, geologists, a natural resource company management and a government participant. In some implementations, the wellbore trajectory (317) is based on properties of the drilling target, properties of the region of interest, or both, determined by the geoscientists from the seismic image (313) and the velocity model (309). After the wellbore trajectory (317) is planned, the wellbore (319) is drilled, perforating the drilling target (315).

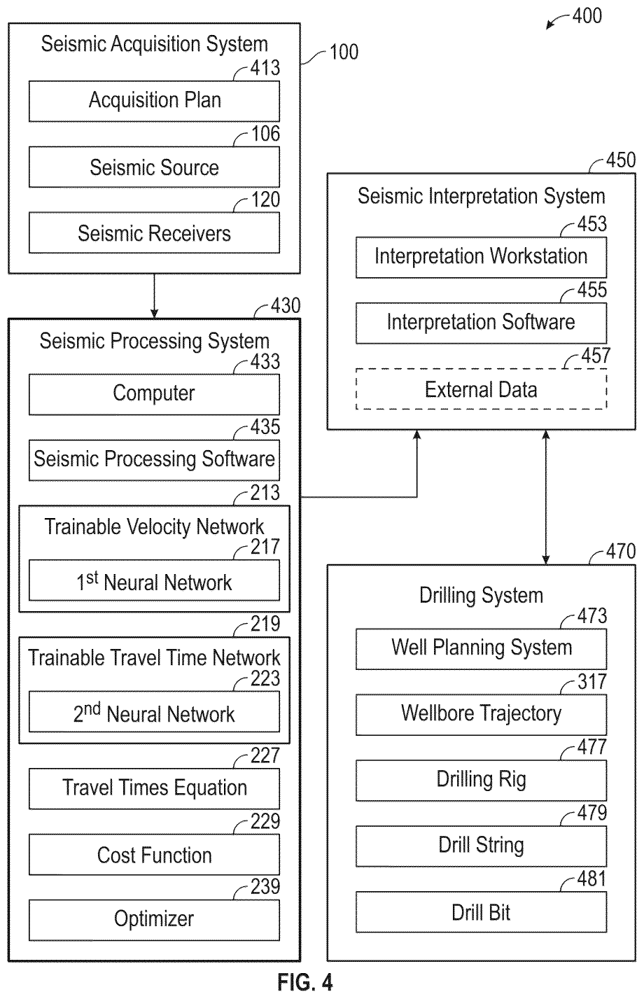

FIG. 4 depicts a system (400) for identifying and drilling through a drilling target, in accordance with one or more embodiments. For brevity, a full description of components and/or elements depicted in FIG. 4 is not provided anew for those components and/or elements that have been previously described with reference to the preceding figures. The system (400) includes the seismic acquisition system (100), a seismic processing system (430), a seismic interpretation system (450) and a drilling system (470). The seismic acquisition system (100), described in FIG. 1, includes the seismic sources (106) and seismic receivers (120). The seismic acquisition system (100) is designed to perform a seismic acquisition. The seismic acquisition is designed to acquire the seismic dataset (209). The seismic acquisition system (100) is deployed according to an acquisition plan (413) that defines the seismic acquisition. The acquisition plan (413) may include various components. Examples of components of the acquisition plan (413) include positions of the seismic sources (106) and positions of the seismic receivers (120). The seismic sources (106) and the seismic receivers (120) are positioned in a way that the region of interest is illuminated by seismic waves emitted by the seismic sources (106) and that seismic data recorded by the seismic receivers (120) may be used to image the subsurface (103). Examples of components of the acquisition plan (413) may further include a list of equipment to be used to perform the seismic acquisition, a timeline for the seismic acquisition, a description of the region of interest, a topographic map of the surface and a description of a personnel needed to perform the seismic acquisition.

The seismic processing system (430) includes the trainable velocity network (213) and the trainable travel time network (219). The trainable velocity network (213) includes, or is, the first neural network (217). The trainable travel tune network (219) includes, or is, the second neural network (223). The seismic processing system (430) is configured to receive the seismic dataset (209) from the seismic acquisition system (100) and train the trainable velocity network (213) and the trainable travel time network (219). Training the seismic acquisition system (100) and train the trainable velocity network (213) is performed according to the system (200) in FIG. 2. The trainable velocity network (213) includes the velocity parameters (215). The trainable travel time network (219) includes the travel time parameters (221). The seismic processing system (430) is further configured to determine observed travel times on the seismic dataset (209), such as the observed travel times (211) in FIG. 2. The seismic processing system (430) is further configured to receive the travel times equation (227) and form the cost function (229), based on, at least, the travel times equation (227), one or more derivatives of the travel times equation (227) and one or more travel time mismatches between observed travel tines (211) and an output of the trainable travel time network (219). The seismic processing system (430) is further configured to determine, with the optimizer (239) that seeks to minimize the cost function (229), the trained velocity parameters (241) and the trained travel tune parameters (243). The seismic processing system (430) is further configured to form the trained velocity network (305) by replacing, in the trainable velocity network (213), the velocity parameters (215) with the trained velocity parameters (241), as performed in the system (300) in FIG. 3. The seismic processing system (430) is further configured to form the trained travel time network (307) by replacing, in the trainable travel time network (219), the travel time parameters (221) with the trained travel time parameters (243), as performed in the system (300) in FIG. 3. The trainable velocity network (213), the trainable travel time network (219) and optimizer (239) are hosted and run on a computer (433).

The seismic processing system (430) is further configured to determine the velocity model (309) of the region of interest, the velocity model (309) including outputs from the trained velocity network (305) upon receiving as inputs, sequentially, the prediction locations within the first plurality of prediction locations. The seismic processing system (430) is further configured to determine the travel time cube (311) in the region of interest, the travel time cube (311) including outputs from the trained travel time network (307) upon receiving as inputs, sequentially, pairs composed of a prediction source location within the plurality of prediction source locations and a prediction location within the second plurality of prediction locations.

The seismic processing system (430) further includes seismic processing software (435), configured to perform processing tasks. The seismic processing system (430) is hosted and run on the computer (433). Seismic processing software (435) may include seismic trace processing tools, such as tools for performing noise attenuation, multiple attenuation, ghost wavefield elimination, re-datuming. P-Z summation, shot and seismic receiver depth correction, frequency filtering, and spectral shaping. Seismic processing software (435) may further include sorting algorithms for sorting seismic traces into different referentials. The seismic processing system (430) may further make use of artificial intelligence (AI) to perform some of the processing tasks.

Seismic processing software (435) further includes one or more imaging algorithms configured to determine the seismic image (313), from the seismic dataset (209), the velocity model (309) and possibly the travel time cube (311). As stated, examples of imaging algorithms include migration algorithms. Examples of migration algorithms include a Kirchhoff migration, a reverse-time migration (RTM), and a beam migration.

Seismic processing software (435) may further include velocity model building tools that may be used for post-processing the velocity model (309). Examples of velocity model building tools include, but are not limited to, a residual moveout (RMO) tomography, a full waveform inversion (FWD), and velocity edition algorithms. A RMO tomography is an inversion algorithm configured to update the velocity model (309) as a first updated velocity model. The first updated velocity model is such that a first position of a seismic reflector on a first image is the same as a second position of the seismic reflector on a second image. The first image is obtained by using an imaging algorithm with a first portion of the seismic dataset (209) and the first updated velocity model as inputs. The second image obtained by using the imaging algorithm with a second portion of the seismic dataset (209) and the first updated velocity model as inputs. In some embodiments, the RMO tomography algorithm includes a wave propagation algorithm, such as a wave ray tracing algorithm. An FWI algorithm is an inversion algorithm configured to update the velocity model (309) as a second updated velocity model. In some embodiments, the second updated velocity model is such that a seismic trace from the seismic dataset (209), with a first seismic source location and a first seismic receiver location, matches a simulated seismic trace computed using the simulator (207) upon receiving, as inputs, the first seismic source location, the first seismic receiver location and the second updated velocity model. Many variations of RMO tomography algorithms and FWI algorithms exist and are distinguished, for example, by their cost functions, or wavefield propagation algorithms. Examples of velocity edition algorithms include velocity smoothing algorithms, velocity interpolation algorithms, and mathematical operators for obtaining or modifying the velocity model (309) arbitrarily.

Seismic processing software (435) may further include visualization software. Visualization software may include various functions allowing for observing general-purpose one-dimensional or multi-dimensional datasets, such as seismic traces, velocity fields, or any attributes extracted from seismic traces of velocity fields. In one or more embodiments, visualization software includes quality control tools, such as algorithms to compute a frequency spectrum, compute a frequency-wavenumber spectrum, sort seismic traces into various domains, compare two different datasets, or compute statistics on seismic data or a velocity field. In one or more embodiments, visualization software further includes processing tools, such as frequency filters, and algorithms to scale amplitudes of seismic traces, smooth depth velocity models, or interpolate velocity fields.

One with ordinary skill in the art will acknowledge that the examples of components or functions of the seismic processing software (435) described herein, including seismic trace processing tools, migration algorithms, velocity model building tools, and visualization software are intended to promote clear discussion and should not be considered fixed or limiting. The seismic processing software (435) may include fewer or additional components from the above-described components without departing from the scope of this disclosure.

The seismic interpretation system (450) is configured to receive, at least, the velocity model (309) and the seismic image (313) from the seismic processing system (430). The seismic interpretation system (450) is used by geoscientists to analyze the seismic image (313) and the velocity model (309). The seismic interpretation system (450) includes an interpretation workstation (453) that allows geoscientists to visualize the seismic image (313) and the velocity model (309). Seismic interpreters may use interpretation software (455), hosted and run on the interpretation workstation (453), to perform the various interpretation tasks previously described in this disclosure, such as interpreting key geological horizons within the seismic image (313). In that respect, the interpretation software (455) may be equipped with various horizon picking tools, such as, for example, a hand-picking tool that allows a seismic interpreter to draw lines on the seismic image (313) and an automatic horizon tracking algorithm. An automatic horizon tracking algorithm allows an interpreter to pick a geological event at a limited number of discreet points, called seed points, in the seismic image (313) and then let the automatic horizon tracking algorithm track the geological event from these seed points, resulting in a horizon. In some embodiments, the interpretation software (455) further includes an artificial intelligence model that receives a depth image as input and returns, as output, a horizon, or a piece of a horizon.

Examples of interpretation tasks further include computing seismic attributes of the seismic image (313), such as a frequency, a gradient, an envelope, or a coherency. The interpretation workstation (453) may further include peripherals such as a monitor, a keyboard, a mouse, and a graphic tablet that enable efficient interaction between seismic interpreters to interact with the interpretation software (455).

Results of the interpretation tasks may enable geoscientists to identify the drilling target (315) depicted in the system (300). In one or more embodiments, identifying the drilling target (315) is further be based on external data (457). Examples of external data (457) include well-log data, geological knowledge, and other geophysical information of the region of interest. As stated, the drilling target (315) may be of many types. Examples of a drilling target include a potential reservoir of a natural resource, an injection site for a material into the subsurface and an extraction site of a material from the subsurface.

In one or more embodiments, properties of the drilling target (315) are determined using the seismic mage (313) and the velocity model (309). In embodiments where the drilling target is a potential hydrocarbon reservoir, examples of properties that may be determined for the potential hydrocarbon reservoir include, but are not limited to, a hydrocarbon distribution within the potential hydrocarbon reservoir, reservoir rock properties, a volume of hydrocarbon within the potential hydrocarbon reservoir, a performance of the potential hydrocarbon reservoir, and a risk assessment. As previously explained in this disclosure, a decision may be made to drill a wellbore (319) perforating the drilling target (315). In one or more embodiments, the decision to drill the wellbore (319) depends on the properties of the drilling target (315). Further, in some embodiments, the decision drill the wellbore (319) is taken by stakeholders in an industry or a governmental entity. Examples of stakeholders include, but are not limited to, seismic interpreters, geologists, a natural resource company management and a government participant.

Following the decision to drill the wellbore (319), a description of the drilling target (315), properties of the drilling target, and other results of the interpretation tasks, such as a structural mapping of the subsurface (103), are sent to a well planning system (473). The well planning system (473) is part of a drilling system (470). The well planning system (473) is structured to plan the wellbore trajectory (317), guided by the drilling target (315). The well planning system (473) is structured to communicate with the seismic interpretation system (450). As previously described, the wellbore trajectory (317) extends from the surface of the Earth to the drilling target (315). The well planning system (473) includes analysis tools, such as computer processors and visualization software. In some embodiments, the well planning system (473) makes use of the seismic interpretation system (450). The well planning system (473) further includes analysts that determine the wellbore trajectory (317). The well planning system (473) may further include a database, in which geographical and geo-political information is stored about the location of the drilling target (315). The well planning system (473) further assists drilling engineers and teams in making strategic decisions to optimize the wellbore trajectory (317) and placement, to design the casing, and to avoid geohazards, based on geological formations and structural complexities. In some embodiments, the wellbore trajectory (317) may further be constrained by surface limitations, such as suitable locations for the surface position of the wellhead, availability and configuration of drilling ships, and the layout of natural or man-made islands. Additionally, the locations of potential or preexisting drilling rigs may be considered. Drilling equipment is then installed around the entrance of the wellbore trajectory (317) in order to perform a drilling operation to perforate the drilling target (315). Drilling equipment may include a drill bit (481) that perforates the subsurface (103). Drilling equipment may further include a drilling rig (477) to suspend a drill string (479), the drill bit (481) mounted on a downhole or distal end of the drill string (479). Greater details surrounding drilling operations are described later in this disclosure.

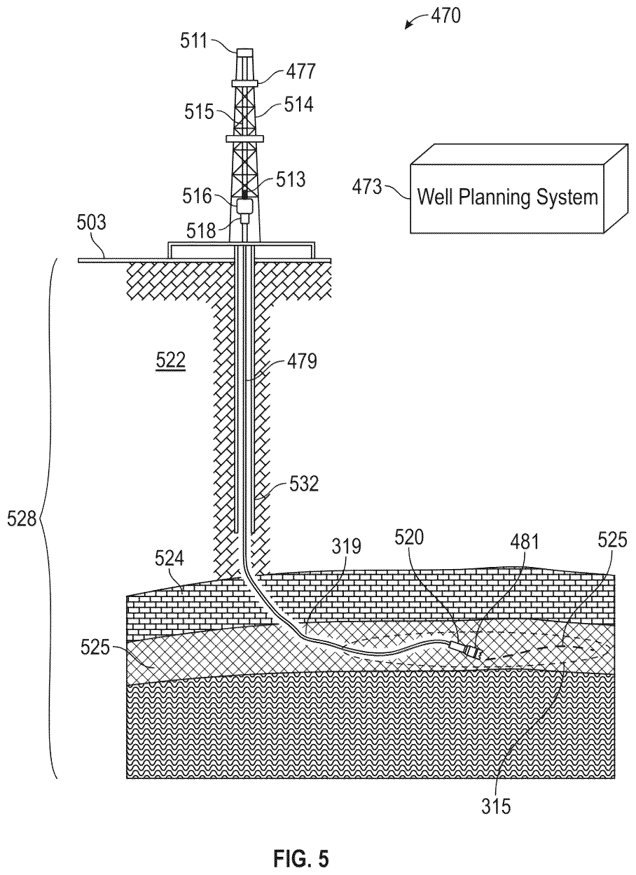

FIG. 5 depicts an example embodiment of the drilling system (470) used m FIG. 4. In this specific embodiment, the drilling target (315) is a potential hydrocarbon reservoir (525). As shown in FIG. 5, the wellbore (319), following the wellbore trajectory (317) may be drilled by the drill bit (481) attached by the drill string (479) to the drilling rig (477) located on the surface of the earth. The drilling rig (477) may include framework, such as a derrick (514) to hold drilling machinery. A crown block (511) may be mounted at the top of the derrick (514), and a traveling block (513) may hang down from the crown block (511) by means of a cable (515) or drilling line. One end of the cable (515) may be connected to a drawworks (not shown), which is a reeling device that may be used to adjust the length of the cable (515) so that the traveling block (513) may move up or down the derrick (514).

A top drive (516) provides clockwise torque via the drive shaft (518) to the drill string (479) in order to drill the wellbore (319). The drill string (479) may comprise a plurality of sections of drillpipe attached at an uphole end to the drive shaft (518) and downhole to a bottomhole assembly (“BHA”) (520). The BHA (520) may include a plurality of sections of heavier drillpipe and one or more measurement-while-drilling (“MWD”) tools configured to measure drilling parameters. Measured drilling parameters may include torque, weight-on-bit, drilling direction, temperature, etc. Additionally, the BHA may have one or more logging tools (e.g., logging-while-drilling (“LWD”)) configured to measure parameters of the rock surrounding the wellbore (319), such as electrical resistivity, density, sonic propagation velocities, gamma-ray emission, etc. MWD tools and logging tools may include sensors and hardware to measure downhole drilling parameters, and these measurements may be transmitted to the surface (503) using any suitable telemetry system known in the art. The BHA (520) and the drill string (479) may include other drilling tools known in the art but not specifically shown.

The wellbore (319) may traverse a plurality of overburden (522) layers and one or more formations (524) to the potential hydrocarbon reservoir (525) within the subsurface (528). The wellbore trajectory (317) may be a curved or a straight trajectory. All or part of the wellbore trajectory (317) may be vertical, and some parts of the wellbore trajectory (317) may be deviated or have horizontal sections. One or more portions of the wellbore (319) may be cased with casing (532) in accordance with a wellbore plan.

Typically, the wellbore plan is generated based on best available information at the time of planning from a geophysical model, geomechanical models encapsulating subterranean stress conditions, the trajectory of any existing wellbores (which it may be desirable to avoid), and the existence of other drilling hazards, such as shallow gas pockets, over-pressure zones, and active fault planes. The drilling system (470) may be used to drill the wellbore (319) along the wellbore trajectory (317) to access the potential hydrocarbon reservoir (525).

To start drilling, or “spudding in” the well, the hoisting system lowers the drill string (479) suspended from the derrick (514) towards the planned surface location of the wellbore (319). An engine or electric motor may be used to supply power to the top drive (516) to rotate the drill string (479) through the drive shaft (518). The weight of the drill string (479) combined with the rotational motion enables the drill bit (481) to bore the wellbore (319).

The drilling system (470) may be disposed at and communicate with other systems in the well environment, such as the seismic processing system (430) and the seismic interpretation system (450) defined in the description of FIG. 4. The drilling system (470) may control at least a portion of a drilling operation by providing controls to various components of the drilling operation. In one or more embodiments, the drilling system (470) may receive well data from one or more sensors and/or logging tools arranged to measure controllable parameters of the drilling operation. During operation of the drilling system (470), the well data may include mud properties, flow rates, drill volume and penetration rates, rock physical properties, etc.

The well planning system (473) helps drilling engineers in designing casing strings and selecting appropriate tubulars based on the wellbore conditions, planned drilling operations, and regulatory requirements. It considers factors such as pressure, temperature, well depth, formation properties, and casing load capacity. Furthermore, the well planning system (473) performs torque and drag analysis to evaluate the forces and stresses acting on the drill string (479) during drilling operations. This analysis helps in identifying potential issues such as differential sticking, buckling, or limitations in the drilling equipment. The well planning system (473) may have the capability to integrate real-time drilling data, such as downhole measurements, drilling parameters, and formation evaluation results. This integration allows engineers to monitor the drilling progress, make on-the-Dy adjustments to the well plan, optimize drilling efficiency, and maintain drilling safety. The well planning system (473) further allows drilling engineers to visualize and interact with wellbore data in a 3D environment. It provides a graphical representation of the planned well trajectory, existing well paths, geological formations, and potential hazards. Furthermore, the well planning system (473) provides tools for generating reports, exporting data, and documenting drilling plans and decisions. These reports can be shared with regulatory agencies, drilling contractors, and other stakeholders to ensure alignment and compliance throughout the drilling lifecycle.

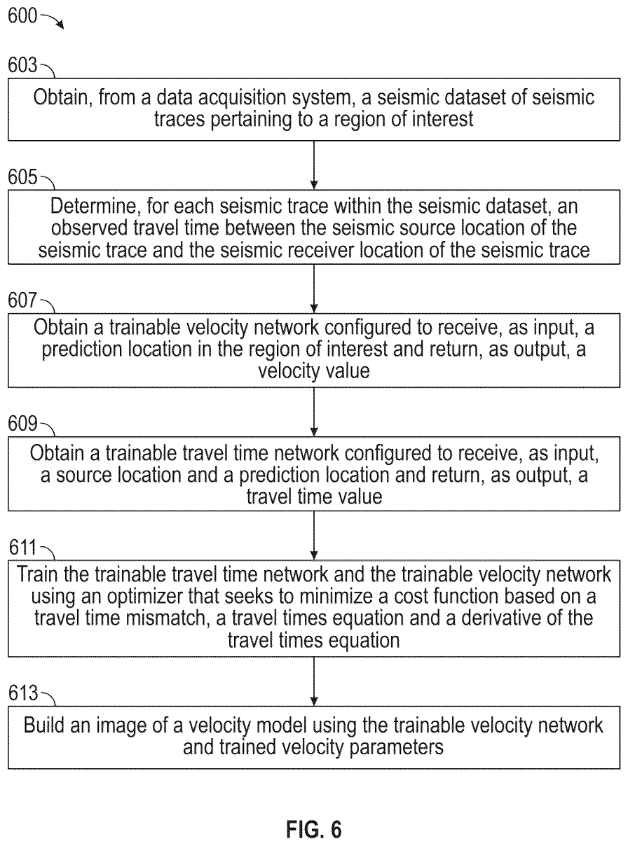

FIG. 6 depicts a method for training travel time based artificial intelligence networks, m accordance with one or more embodiments. In Step 603, a seismic dataset of seismic traces may be obtained from a data acquisition system. The seismic dataset pertains to a D-dimensional region of interest. The data acquisition system may be of many types. An example of a data acquisition system is given by the data acquisition system (203) in FIG. 2. In some embodiments, the data acquisition system includes a seismic acquisition system, such as the seismic acquisition system (100) in FIG. 1. In some embodiments, the data acquisition system includes a simulator, such as the simulator (207) in FIG. 2, which may include a wave propagator. In a similar fashion to the seismic dataset (209) in FIG. 2, the seismic dataset in Step 603 may include one or more seismic traces. Each seismic trace within the seismic dataset includes a seismic source location from where a seismic source originates, and a seismic receiver location, where seismic waves are received after traveling from the seismic source location.

In Step 605, an observed travel time may be determined for each seismic trace with the seismic dataset from Step 603. As such, one or more observed travel times are determined in Step 605. For each seismic trace, the observed travel time T_{obs}(S, R) is a time it takes for a seismic wave to travel from the seismic source location S of the seismic trace to the seismic receiver location R of the seismic trace, through the region of interest. The observed travel time for each seismic trace in Step 605 can be determined in the same way as the observed travel times (211) in FIG. 2, such as, for example, by picking a first arrival on the seismic trace.

In Step 607, a trainable velocity network is obtained. The trainable velocity network may be a first machine learning model and include a first set of one or more parameters, called the velocity parameters α_{V}. The trainable velocity network, denoted as N_{V}, may be configured in a similar fashion to the trainable velocity network (213) in FIG. 2. The trainable velocity network may be configured to receive, as input, a prediction location X in the region of interest, and returns, as output, a velocity value N_{V}(α_{V}, X). The trainable velocity network in Step 607 may be configured in many ways and include one or more machine learning algorithms. In Step 609, a trainable travel time network is obtained. The trainable travel time network may be a second machine learning model and includes a first set of one or more parameters, called the travel time parameters α_{T}. The trainable travel time network, denoted as N_{T}, may be configured in a similar fashion to the trainable travel time network (219) in FIG. 2. The trainable travel the network is configured to receive, as input, a source location Xₛ, in the region of interest, and a prediction location X in the region of interest. The trainable travel time network is configured to return, as output, a travel time value N_{T}(α_{T}, Xₛ, X). The trainable travel time network in Step 609 may be configured in many ways and include one of more machine learning algorithms.

Examples of machine learning algorithms that may be included in the trainable velocity network from Step 607 and the trainable travel time network from Step 609 include supervised machine learning models such as a decision tree regressor, a polynomial regression model, a non-linear regression model, or any combination thereof. In one or more embodiments, the trainable velocity network includes, or is, a first neural network and the trainable travel time network includes, or is, a second neural network. Each of the first neural network and the second neural network may include, for example, a fully connected neural network, a convolutional neural network, a recurrent neural network (RNN), a long short term memory (LSTM) network, a gated recurrent unit (GRU), a transformers model, or any combination of fully connected, convolutional, recurrent. LSTM, GRU, normalization, pooling, dropout and regularization layers. The trainable velocity network and the trainable travel time network may include other components or structures outside of the ones described herein without departing from the scope of this disclosure.

In Step 611, the trainable velocity network and the trainable travel time network are trained using a training procedure. The training procedure includes obtaining a travel times equation modeling a travel tune of a seismic wave in the region of interest according to a seismic velocity. The travel times equation is based on a travel times formula, such as, for example, the travel times formula in EQ. 1. In some embodiments, the travel times formula is the Eikonal equation in EQ. 2. In some embodiments, the travel times formula is the isotropic Eikonal equation in EQ. 3. The travel times formula includes terms featuring a travel time function T. The travel time function T is configured to receive, as inputs, a source location Xₛ in the region of interest and a location X in the region of interest. The travel time function T is configured to return, as output, a travel time T(Xₛ, X) of a seismic wave between the source location X, and the location X. Terms of the travel times formula further include a velocity function V. The velocity function V is configured to receive, as input, a location X, and return, as output, a seismic velocity V(X) of the seismic wave at the location X. The travel times equation in Step 611 is obtained by replacing, in the travel time formula, the travel time function T with the trainable travel time network N_{T} and the velocity function V with the trainable velocity network N_{V}. Examples of the travel times equation are given in EQ. 4, EQ. 5 and EQ. 6.

The training procedure further includes constructing a cost function configured to receive, as inputs, the velocity parameters α_{V} and the travel time parameters α_{T}. The cost function returns, as outputs, a cost. Examples of the cost function in Step 611 include the cost function (229) in FIG. 2. The cost is based on, at least, the travel times equation, a derivative of the travel times equation, and one or more training travel tune mismatches. The seismic dataset from step 603 is split into a training seismic dataset and a testing seismic dataset. The seismic traces of the training seismic dataset are called training seismic traces. The seismic traces of the testing seismic dataset are called testing seismic. It is common practice to split the seismic dataset in a way that the training seismic dataset contains more seismic traces than the testing seismic dataset. Because data splitting is a common practice when training and testing a machine-learned model, it is not described m detail in this disclosure. One with ordinary skill in the art will recognize that any data splitting technique may be applied to the seismic dataset without departing from the scope of this disclosure. In some embodiments, the training seismic dataset is the whole seismic dataset from Step 603. A training travel time mismatch is defined as a difference between a first observed travel time from Step 605, for a training trace with a first seismic source location S, and a first seismic receiver location R₁, and the travel time value N_{T}(α_{T}, S₁, R₁) obtained as output from the trainable travel time network. In some embodiments, the cost function in Step 611 includes the first term A₁(α_{T}) from EQ. 7 or EQ. 8, the second term A₂(α_{V}, α_{T}) from EQ. 9, EQ. 10, EQ. 11, or EQ. 12, and the third term A₃(α_{V}, α_{T}) from EQ. 13 or EQ. 14. It is noted that there are many configurations in which the cost function may be based on the travel times equation and its derivatives. In EQs 9-14, outputs of the trainable travel time network, N_{T}(α_{T}, X_{s,i}, Xⱼ), are evaluated at a number of nₛ≥1 training source locations, denoted as X_{s,i}, for 1≤i≤nₛ, and a number nₚ≥1 of training locations, denoted as Xⱼ, for 1≤j≤nₚ. The outputs of the trainable velocity network, N_{V}(α_{V}, Xⱼ), are evaluated at the training locations Xⱼ, for 1≤j≤nₚ.

In some embodiments, the cost function from Step 611 is further based on an interface condition associated with the travel times formula, such as the interface condition from EQ. 15, EQ. 16 or EQ. 17. By construction of the travel times equation, the interface condition is also associated with the travel times equation. In some embodiments, the cost function includes the fourth term A₄(α_{V}, α_{T}) from EQ. 18, EQ. 19, EQ. 20 or EQ. 21. In some embodiments, the cost function includes a term that aims to enforce the travel times values N_{T}(α_{T}, X_{s,i}, Xⱼ) to be non-negative for 1≤i≤nₛ, for 1≤j≤nₚ. An example of such a term is given by the term A₅(α_{T}) from EQ. 22 or EQ. 23 In some embodiments, the cost function includes a term that aims to enforce the first component

$${N}_{V}^{1} ( {α}_{V} , {X}_{j} )$$

of the velocity values N_{V}(α_{V}, Xⱼ) to be greater than a minimum value Vₘᵢₙ≥0, for 1≤j≤nₚ. In such embodiments, the cost may include the term A₆(α_{V}) from EQ. 24 or EQ. 25. In some implementations, the cost function in Step 611 is given by EQ. 26. In some implementations, the cost function in Step 611 is given by EQ. 27. Specific embodiments for EQ. 27 are given by EQ. 28 and EQ. 29.

The training procedure may further include computing, with an optimizer, one or more trained travel times parameters and one or more trained velocity parameters. The optimizer may be configured to seek to minimize the cost function in the sense of EQ. 27. Examples of optimizers included in the training procedure include the optimizer (239) in FIG. 2. In some embodiments, the optimizer is an iterative optimizer, previously described in this disclosure. In some embodiments, the optimizer is a gradient descent method. The velocity parameters are denoted as \hat{α}_{V} and the trained travel time parameters are denoted as \hat{α}_{T}. A trained velocity network is obtained by using, in the trainable velocity network, the trained velocity parameters \hat{α}_{V} in lieu of the velocity parameters \hat{α}_{V}. A trained travel time network is obtained by using, in the trainable travel time network, the trained travel time parameters \hat{α}_{T} in lieu of the travel time parameters α_{T}.

In Step 613, an image of an evaluation velocity model is built using the trained velocity network. Given a set of evaluation locations in the region of interest, denoted as

$${X}_{j}^{P} ,$$

for 1≤j≤nₗ, an evaluation velocity model is formed by inputting the evaluation locations to the trained velocity network. That is, the evaluation velocity model is a set including values

$${N}_{V} ( {\hat{α}}_{V} , {X}_{j}^{P} ) ,$$

for 1≤j≤nₗ. In some embodiments, the evaluation velocity model is the set composed of pairs

$$( {X}_{j}^{P} , {N}_{V} ( {\hat{α}}_{V} , {X}_{j}^{P} ) ) .$$

In some embodiments, the evaluation velocity model represents a velocity of seismic waves in the region of interest. Examples of the image of the evaluation velocity model are given by the image (245) and may be a two-dimensional representation of the evaluation velocity model on a screen, a file, or a physical support such as a piece of paper, plastic or metal.

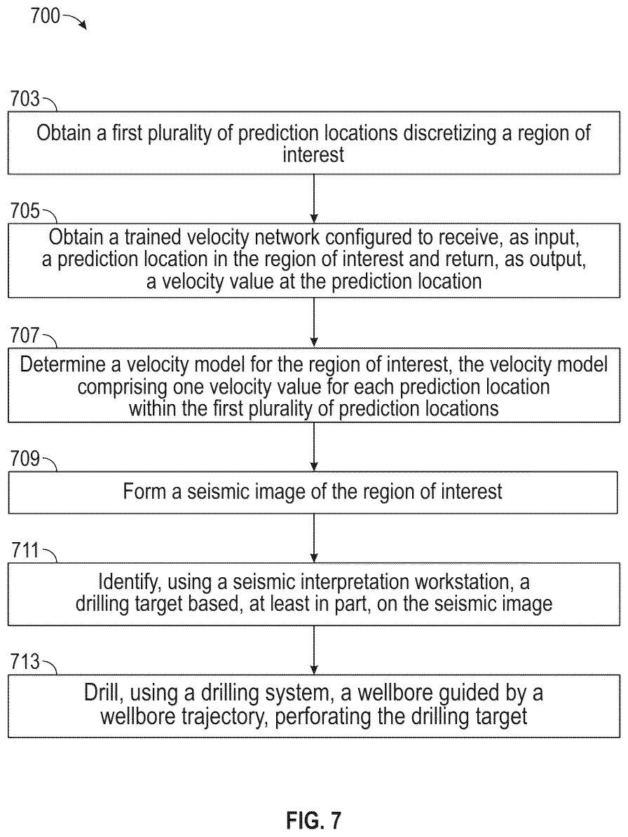

A flowchart in FIG. 7 depicts a method for using a trained velocity network to compute a velocity model in a region of interest, among other uses, in accordance with one or more embodiments. In Step 703, a first plurality of prediction locations is formed as a set of

$${n}_{W}^{V}$$

distinct points, denoted as

$${W}_{i}^{V} ,$$

for

$$1 \leq i \leq {n}_{W}^{V} .$$

The first plurality of prediction locations forms a first discretization of the region of interest. In one or more embodiments, the first discretization, formed by the first plurality of prediction locations, is regular, as previously described in this disclosure.

In Step 705, a trained velocity network is obtained. The trained velocity network is based on one or more trained velocity parameters, denoted as \hat{α}_{V}. The trained velocity network is configured to receive, as input, a prediction location, in the region of interest and return, as output, a velocity value at the prediction location. The one or more trained velocity parameters are determined by using an optimizer that seeks to minimize a cost function. The cost function is based on a travel tunes equation and a derivative of the travel times equation. Examples of the cost function in Step 705 include the cost function n (229) in FIG. 2. Examples of the optimizer in Step 705 include the optimizer (239) in FIG. 2. The travel times equation models a travel time of a seismic wave in the region of interest according to a seismic velocity. The travel times equation is based on a trainable velocity network, denoted as N_{V}, and a trainable travel time network, denoted as N_{T}. Examples of the trainable velocity network are given by the trainable velocity network in Step 607 of the method (600) in FIG. 6 or the trainable velocity network (213) in FIG. 2. Examples of the trainable travel time network are given by the trainable travel time network in Step 609 of the method (600) or the trainable travel time network (219) in FIG. 2.

The trainable velocity network may be a first machine learning model, based on velocity parameters, denoted as α_{V}. The trainable velocity network may be configured to receive, as input, a prediction location X and return, as output, a velocity value N_{V}(α_{V}, X). Examples of the cost function include the cost function from Step 611 of the method in FIG. 6 and the cost function (229) in FIG. 2. Examples of the cost function are given in EQ. 26, EQ. 27, EQ. 28 and EQ 29. The trained velocity network is obtained by replacing, in the trainable velocity network. N_{V}, the trainable velocity parameters α_{V} with the trained velocity parameters \hat{α}_{V}. An example of a trained velocity network is given by the trained velocity network (305) in FIG. 3. Examples of machine learning algorithms that may be included in the trainable velocity network, or the trainable travel time network, or both include supervised machine learning models such as a decision tree regressor, a polynomial regression model, a non-linear regression model, or any combination thereof. In one or more embodiments, the trainable velocity network includes, or is, a first neural network and the trainable travel time network includes, or is, a second neural network.

A velocity model, for the region of interest, as determined in Step 707, in a similar fashion to the velocity model (309) in FIG. 3. The velocity model is obtained by inputting the prediction locations

$${W}_{i}^{V}$$

from Step 603 to the trained velocity network from Step 605, for 1≤i≤

$${n}_{W}^{V} .$$

Thus, the velocity model includes a plurality of velocity values, Vᵢ, for

$$1 \leq i \leq {n}_{W}^{V} .$$

Each velocity value, Vᵢ, is defined as an output to the trained velocity network (305) associated with a point

$${W}_{i}^{V} ,$$

which means:

$${V}_{i} = {N}_{V} ( {\hat{a}}_{V} , {W}_{i}^{V} ) ,$$

for

$$1 \leq i \leq {n}_{W}^{V} .$$

In some implementations, the velocity model is defined as a set of pairs

$$( {W}_{i}^{V} , {V}_{i} ) ,$$

for

$$1 \leq i \leq {n}_{W}^{V} .$$

In some implementations, the velocity model is composed of the velocity values Vᵢ and a correspondence mapping between each velocity value Vᵢ and the point

$${W}_{i}^{V}$$

associated with the velocity value Vᵢ, for

$$1 \leq i \leq {n}_{W}^{V} .$$

In some embodiments, the trainable travel time network N_{T}, from the travel times equation in Step 705, is based on travel time parameters α_{T} and the cost function further receives the travel time parameters α_{T} as input, in addition to the velocity parameters α_{V}. The trainable travel time network is configured to receive, as input, a source location Xₛ in the region of interest and a prediction location X in the region of interest. The trainable travel time network is configured to return, as output, a travel time value N_{T}(α_{T}, Xₛ, X). In such embodiments, the optimizer, by seeking to minimize the cost function, further outputs one or more trained travel time parameters \hat{α}_{T}. A trained travel time network is obtained by replacing, in the trainable velocity network N_{T}, the trainable travel time parameters α_{T}, with the trained travel time parameters \hat{α}_{T}. A number

$${n}_{W}^{S} > 1$$

of prediction source locations are selected and denoted as

$${W}_{S , i}^{T} ,$$

for

$$1 \leq i \leq {n}_{W}^{S} .$$

A second plurality of prediction locations is formed as a set of

$${n}_{W}^{T}$$

distinct points, denoted as

$${W}_{i}^{T} ,$$

for

$$1 \leq i \leq {n}_{W}^{T} ,$$

that form a second discretization of the region of interest. The prediction source locations may be defined in many ways, in a similar fashion to the training source locations (231) in FIG. 2. In some implementations, the prediction source locations are located on a line pertaining to the region of interest. In some implementations, the prediction source locations discretize a portion of the boundary of the region of interest. In some implementations, the boundary of the region of interest includes a surface of the Earth and the prediction source locations discretize the surface. In some implementations, the prediction source locations are located on a vertical line originating from the surface. In some implementations, the second plurality of prediction locations is the first plurality of prediction locations in Step 703. In one or more embodiments, the second discretization is regular.

A travel time cube, for the region of interest, is determined by inputting the prediction source locations

$${W}_{S , i}^{T}$$

and the prediction locations

$${W}_{j}^{T}$$

to the trained travel time network, in a similar fashion to the travel time cube (311) in FIG. 3. Thus, the travel time cube includes a plurality of travel time value, T_{i,j}, for

$$1 \leq i \leq {n}_{W}^{S} ,$$

for

$$1 \leq j \leq {n}_{W}^{T} .$$

Each travel time value is defined as an output to the trained travel time network associated with a prediction source location

$${W}_{S , i}^{T}$$

and a prediction location

$${W}_{j}^{T} .$$

which means:

$${T}_{i , j} = {N}_{T} ( {\hat{α}}_{T} , {W}_{S , i}^{T} , {T}_{j} ) ,$$

for

$$1 \leq i \leq {n}_{W}^{S} ,$$

for

$$1 \leq j \leq {n}_{W}^{T} .$$

In some implementations, the travel time cube is defined as a set of the triplets

$$( {W}_{S , i}^{T} , {W}_{j}^{T} , {T}_{i , j} ) ,$$

for

$$1 \leq {n}_{w}^{S} ,$$

for

$$1 \leq j \leq {n}_{w}^{T} .$$

In some implementations, the travel time cube is composed of the travel time values T_{i,j}, and a correspondence mapping between each travel time values T_{i,j} and the pair

$${W}_{S , i}^{T} , {W}_{j}^{T}$$

associated with the travel time values T_{i,j}, for

$$1 \leq i \leq {n}_{W}^{S} ,$$

for

$$1 \leq j \leq {n}_{W}^{T} .$$

In one or more embodiments, a seismic image of the region of interest is formed in Step 709. The seismic image is based on the travel time cube, the velocity model from Step 705, and a seismic dataset of seismic traces pertaining to the region of interest. The seismic dataset is acquired using a seismic acquisition system, such as the seismic acquisition system in FIG. 1. Each seismic trace within the seismic dataset includes a seismic source location and a seismic receiver location. For each seismic trace, a receiver at the seismic receiver location of the seismic trace detects ground motion of a seismic wave radiating from the seismic source location of the seismic trace. Examples of the seismic dataset include the seismic dataset (209) in FIG. 3. The seismic image in Step 709 represents an image of the region of interest. The seismic image is two-dimensional or three-dimensional. In some implementation, the last dimension of the seismic image represents a depth. In other implementations, the last dimension of the seismic image represents time. The seismic image is computed using an imaging algorithm that receives, as inputs, the seismic dataset, the velocity model and the travel time cube. Examples of imaging algorithms that make use of travel times as input include a Kirchhoff migration algorithm, previously described in this disclosure.

In one or more embodiments, a drilling target is identified in Step 711, using a seismic interpretation workstation. The drilling target is identified based on the seismic image from Step 709, in a similar fashion to the drilling target (315), determined based on the seismic image (313) in FIG. 3. An example of the interpretation workstation in Step 711 is given by the interpretation workstation (453) in FIG. 4. In some embodiments, the interpretation workstation is included in a seismic interpretation system, such as the seismic interpretation system (450) in FIG. 4. The drilling target in Step 711 may be of many types, including, but not limited to a potential reservoir of a natural resource, an injection site for a material into the subsurface and an extraction site of a material from the subsurface. Generally, the drilling target is determined by one or more geoscientists performing one or more interpretation tasks using the interpretation workstation. Examples of interpretation tasks include the tasks including interpreting key geological horizons that delimit stratigraphic layers, boundaries, and structural features of the subsurface. Examples of interpretation tasks further include computing seismic attributes of the depth image, such as a frequency, a gradient, an envelope, and a coherency. Results of the interpretation tasks enable the geoscientists to locate the drilling target. In some embodiments, the geoscientists produce a map of the drilling target, properties of the drilling target and properties of the region of interest. In some embodiments, the geoscientists make use of the velocity model from Step 705 to perform the interpretation tasks.

In one or more embodiments, a wellbore trajectory perforating the drilling target is planned, using a well planning system, guided by the drilling target. Based on the drilling target from Step 711. The wellbore trajectory is planned in a similar fashion to the wellbore trajectory (317) in FIG. 3. In some implementations, the wellbore trajectory is based on properties of the drilling target, properties of the region of interest, or both, determined by the geoscientists from the seismic image and the velocity model. In some embodiments, the wellbore trajectory is constrained by surface limitations, such as hazardous terrain, availability and configuration of drilling equipment, and layout of natural or man-made islands. Additionally, the locations of potential or preexisting drilling sites may be considered. In one or more embodiments, the decision drill a wellbore is taken by stakeholders in an industry or a governmental entity. Examples of stakeholders include, but are not limited to, seismic interpreters, geologists, a natural resource company management and a government participant.

The well planning system is similar to the well planning system (473) in FIG. 4. As such, the well planning system may be part of a drilling system, such as the drilling system (470) in FIG. 4. As such, the well planning system is structured to communicate with the seismic interpretation system to determine the wellbore trajectory. The well planning system includes analysis tools, such as one or more computer processors and visualization software. The well planning system may further include analysts that determine the wellbore trajectory. The well planning system may further include a database, in which geographical and geo-political information is stored about the location of the drilling target. In some embodiments, the well planning system makes use of the seismic interpretation system. The well planning system may further assist drilling engineers and teams in making strategic decisions to optimize the wellbore trajectory and placement. In one or more embodiments, a wellbore is drilled in Step 713, guided by the wellbore trajectory. Examples of a drilling system include the drilling system (470) in FIG. 4, an embodiment of which is depicted in FIG. 5.

As previously described, the trainable velocity network represented in various systems and methods of this disclosure, such as the trainable velocity network (213) in FIG. 2, the trainable velocity network in Step 607 of the method 600, and the trainable velocity network m Step 705 of the method 700, includes, or is, a first machine learning model. As previously described, the trainable travel time network represented in various systems and methods of this disclosure, such as the trainable travel time network (219) in FIG. 2, the trainable travel time network in Step 609 of the method 600, and the trainable travel time network in Step 705 of the method 700 includes, or is, a second machine learning model. The first machine learning model and the second machine learning model may be configured in many ways. Machine learning (ML), broadly defined, is the extraction of patterns and insights from data. The phrases “artificial intelligence,” “machine learning.” “deep learning,” and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning will be adopted herein, however, one skilled in the art will recognize that the concepts and methods detailed hereafter are not limited by this choice of nomenclature.

Machine learning model types may include, but are not limited to, generalized linear models, Bayesian regression, random forests, and deep models such as neural networks, convolutional neural networks, and recurrent neural networks. ML model types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding a ML model is referred to as selecting the model “architecture.” Once a ML model type and hyperparameters have been selected, the ML model is trained to perform a task. In the context of this disclosure, the trainable velocity network (213) and the trainable travel time network (219) are trained by using the optimizer (239) that seeks to minimize the cost function (229).

A notable example of the first ML model that may be used as the trainable velocity network is a first neural network (NN) A notable example of the second ML model that may be used as the trainable travel time network is a second NN. A cursory introduction to a NN is provided herein. However, it is noted that many variations of a NN exist. Therefore, one with ordinary skill m the art will recognize that any variation of the NN (or any other AI model) may be employed without departing from the scope of this disclosure. Further, it is emphasized that the following discussions of a NN is a basic summary and should not be considered limiting.

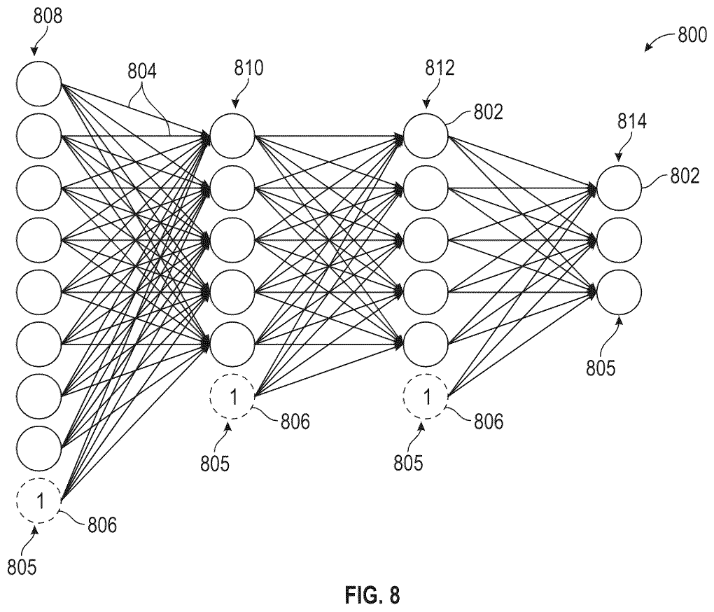

A diagram of a neural network is shown m FIG. 8. At a high level, a neural network (800) may be graphically depicted as being composed of nodes (802), where here any circle represents a node, and edges (804), shown here as directed lines. The nodes (802) may be grouped to form layers (SOS). FIG. 8 displays four layers (808, 810, 812, 814) of nodes (802) where the nodes (802) are grouped into columns, however, the grouping need not be as shown in FIG. 8. The edges (804) connect the nodes (802). Edges (804) may connect, or not connect, to any node(s) (802) regardless of which layer (805) the node(s) (802) is in. That is, the nodes (802) may be sparsely and residually connected. A neural network (800) will have at least two layers (805), where the first layer (808) is considered the “input layer” and the last layer (814) is the “output layer.” Any intermediate layer (810, 812) is usually described as a “hidden layer” A neural network (800) may have zero or more hidden layers (810, 812) and a neural network (800) with at least one hidden layer (810, 812) may be described as a “deep” neural network or as a “deep learning method.” In general, a neural network (800) may have more than one node (802) in the output layer (814). In this case the neural network (800) may be referred to as a “multi-target” or “multi-output” network.

Nodes (802) and edges (804) carry additional associations. Namely, every edge is associated with a numerical value. The edge numerical values, or even the edges (804) themselves, are often referred to as “weights” or “parameters.” While training a neural network (800), numerical values are assigned to each edge (804). Additionally, every node (802) is associated with a numerical variable and an activation function. Activation functions are not limited to any functional class, but traditionally follow the form

$$A = f ( {Σ}_{i ∈ ( incoming )} [ {( node value )}_{i} {( edge value )}_{i} ] ) , \qquad EQ . 34$$

where i is an index that spans the set of “incoming” nodes (802) and edges (804) and f is a user-defined function. Incoming nodes (802) are those that, when the neural network (800) is viewed or depicted as a directed graph (as in FIG. 8), have directed arrows that point to the node (802) where the numerical value is being computed. Some functions for/may include the linear function ƒ(x)=x, sigmoid function

$$f ( x ) = \frac{1}{1 + {e}^{- x}} ,$$

and rectified linear unit function ƒ(x)=max(0, x), however, many additional functions are commonly employed. Every node (802) in a neural network (800) may have a different associated activation function. Often, as a shorthand, activation functions are described by the function/by which it is composed. That is, an activation function composed of a linear function/may simply be referred to as a linear activation function without undue ambiguity.

When the neural network (800) receives an input, the input is propagated through the network according to the activation functions and incoming node (802) values and edge (804) values to compute a value for each node (802). That is, the numerical value for each node (802) may change for each received input. Occasionally, nodes (802) are assigned fixed numerical values, such as the value of 1, that are not affected by the input or altered according to edge (804) values and activation functions. Fixed nodes (802) are often referred to as “biases” or “bias nodes” (806), displayed in FIG. 8 with a dashed circle.

In some implementations, the neural network (800) may contain specialized layers (805), such as a normalization layer, or additional connection procedures, like concatenation. One skilled in the art will appreciate that these alterations do not exceed the scope of this disclosure.

As noted, the training procedure for the neural network (800) comprises assigning values to the edges (804). To begin training the edges (804) are assigned initial values. These values may be assigned randomly, assigned according to a prescribed distribution, assigned manually, or by some other assignment mechanism. Once edge (804) values have been initialized, the neural network (800) may act as a function, such that it may receive inputs and produce an output. As such, at least one input is propagated through the neural network (800) to produce an output.

With respect to a CNN, it is useful to consider a structural grouping, or group, of weights. Such a group is herein referred to as a “filter.” The number of weights in a filter is typically much less than the number of inputs. In a CNN, the filters can be thought as “sliding” over, or convolving with, the inputs to form an intermediate output or intermediate representation of the inputs which still possesses a structural relationship Like unto the neural network (800), the intermediate outputs are often further processed with an activation function. Many filters may be applied to the inputs to form many intermediate representations. Additional filters may be formed to operate on the intermediate representations creating more intermediate representations. This process may be repeated as prescribed by a user. There is a “final” group of intermediate representations, wherein no more filters act on these intermediate representations. In some instances, the structural relationship of the final intermediate representations is ablated; a process known as “flattening.” The flattened representation may be passed to a neural network (800) to produce a final output. Note, that in this context, the neural network (800) is still considered part of the CNN.

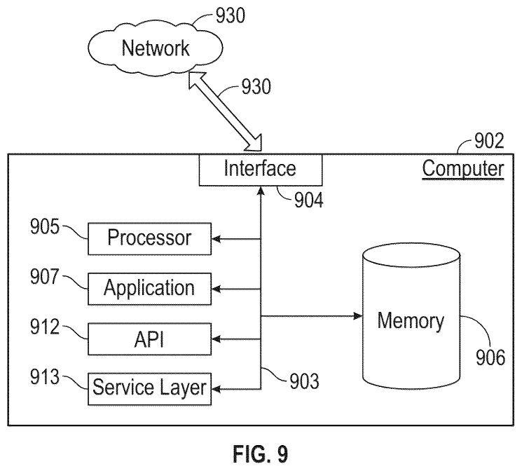

The computations mentioned in this disclosure may be performed by a computer, such as the computer (433) in FIG. 4. In that regard, FIG. 9 depicts a block diagram of a computer (902) used to provide computational functionalities associated with described algorithms, methods, functions, processes, flows, and procedures as described in this disclosure, according to one or more embodiments. The illustrated computer (902) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (902) may include a computer that includes an input device, such as a keypad, keyboard, touch screen, or other device that can accept user information, and an output device that conveys information associated with the operation of the computer (902), including digital data, visual, or audio information (or a combination of information), or a GUI.

The computer (902) can serve in a role as a client, network component, a server, a database or other persistency, or any other component for a combination of roles) of a computer system for performing the subject matter described in the instant disclosure. In some implementations, one or more components of the computer (902) may be configured to operate within environments, including cloud-computing-based, local, global, or other environments (or a combination of environments).

At a high level, the computer (902) is an electronic computing device operable to receive, transmit, process, store, or manage data and information associated with the described subject matter. According to some implementations, the computer (902) may also include or be communicably coupled with an application server, e-mail server, web server, caching server, streaming data server, business intelligence (BI) server, or other server (or a combination of servers).

The computer (902) can receive requests over network (930) from a client application (for example, executing on another computer (902) and responding to the received requests by processing the said requests in an appropriate software application. In addition, requests may also be sent to the computer (902) from internal users (for example, from a command console or by other appropriate access method), external or third-parties, other automated applications, as well as any other appropriate entities, individuals, systems, or computers.

Each of the components of the computer (902) can communicate using a system bus (903). In some implementations, any or all of the components of the computer (902), both hardware or software (or a combination of hardware and software), may interface with each other or the interface (904) (or a combination of both) over the system bus (903) using an application programming interface (API) (912) or a service layer (913) (or a combination of the API (912) and service layer (913). The API (912) may include specifications for routines, data structures, and object classes. The API (912) may be either computer-language independent or dependent and refer to a complete interface, a single function, or even a set of APIs. The service layer (913) provides software services to the computer (902) or other components (whether or not illustrated) that are communicably coupled to the computer (902). The functionality of the computer (902) may be accessible for all service consumers using this service layer. Software services, such as those provided by the service layer (913), provide reusable, defined business functionalities though a defined interface. For example, the interface may be software written in JAVA, C++, or other suitable language providing data in extensible markup language (XML) format or another suitable format. While illustrated as an integrated component of the computer (902), alternative implementations may illustrate the API (912) or the service layer (913) as stand-alone components m relation to other components of the computer (902) or other components (whether or not illustrated) that are communicably coupled to the computer (902). Moreover, any or all parts of the API (912) or the service layer (913) may be implemented as child or sub-modules of another software module, enterprise application, or hardware module without departing from the scope of this disclosure.

The computer (902) includes an interface (904). Although illustrated as a single interface (904) in FIG. 9, two or more interfaces (904) may be used according to particular needs, desires, or particular implementations of the computer (902). The interface (904) is used by the computer (902) for communicating with other systems in a distributed environment that are connected to the network (930). Generally, the interface (904) includes logic encoded in software or hardware (or a combination of software and hardware) and operable to communicate with the network (930). More specifically, the interface (904) may include software supporting one or more communication protocols associated with communications such that the network (930) or interface's hardware is operable to communicate physical signals within and outside of the illustrated computer (902).

The computer (902) includes at least one computer processor (905). Although illustrated as a single computer processor (905) in FIG. 9, two or more processors may be used according to particular needs, desires, or particular implementations of the computer (902). Generally, the computer processor (905) executes instructions and manipulates data to perform the operations of the computer (902) and any algorithms, methods, functions, processes, flows, and procedures as described in the instant disclosure.

The computer (902) also includes a memory (906) that holds data for the computer (902) or other components (or a combination of both) that can be connected to the network (930). The memory may be a non-transitory computer readable medium. For example, memory (906) can be a database storing data consistent with this disclosure. Although illustrated as a single memory (906) in FIG. 9, two or more memories may be used according to particular needs, desires, or particular implementations of the computer (902) and the described functionality. While memory (906) is illustrated as an integral component of the computer (902), in alternative implementations, memory (906) can be external to the computer (902).

The application (907) is an algorithmic software engine providing functionality according to particular needs, desires, or particular implementations of the computer (902), particularly with respect to functionality described in this disclosure. For example, application (907) can serve as one or more components, modules, applications, etc. Further, although illustrated as a single application (907), the application (907) may be implemented as multiple applications (907) on the computer (902). In addition, although illustrated as integral to the computer (902), in alternative implementations, the application (907) can be external to the computer (902).

There may be any number of computers such as the computer (902) associated with, or external to, a computer system containing computer (902), wherein each computer (902) communicates over network (930). Further, the term “client,” “user,” and other appropriate terminology may be used interchangeably as appropriate without departing from the scope of this disclosure. Moreover, this disclosure contemplates that many users may use one computer (902), or that one user may use multiple computers such as the computer (902).

The following examples are merely illustrative and should not be interpreted as limiting the scope of the present disclosure.

### EXAMPLES

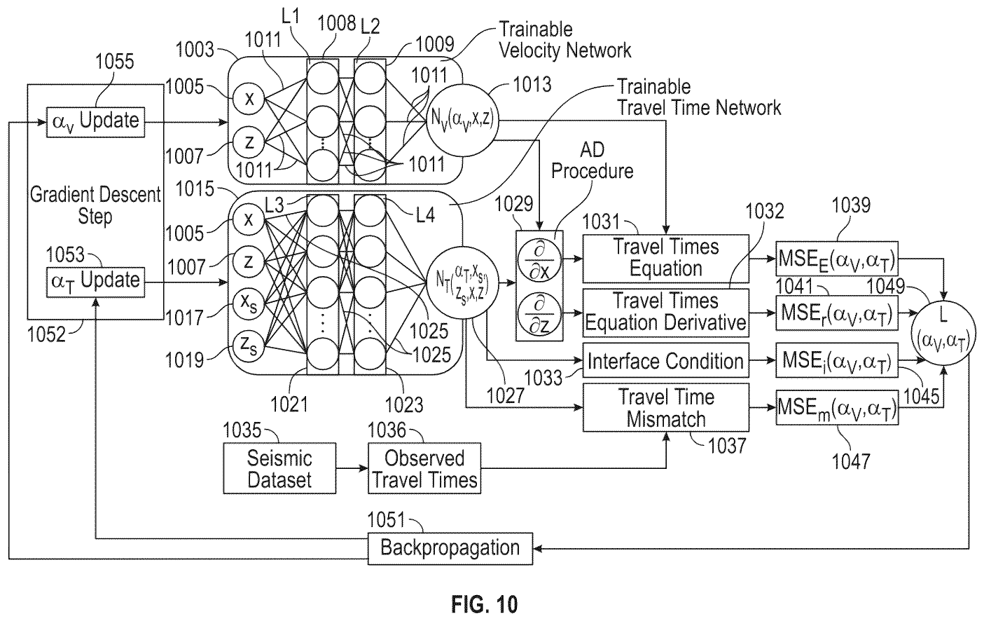

FIG. 10 depicts a schematic example implementation of the training procedure, defined in this disclosure, for training the trainable velocity network and the trainable travel time network. The training procedure is described, for example, in FIGS. 2 and 6. In the specific example in FIG. 10, the region of interest is two-dimensional (D=2). A point X=(x, z) in the region of interest is characterized by a lateral component x (1005), and a depth component z (1007). The travel times formula is an isotropic Eikonal equation equivalent to EQ. 3, in two space dimensions, using the l²-norm:

$${( \frac{\partial T}{\partial x} ( {x}_{s} , {z}_{s} , x , z ) )}^{2} + {( \frac{\partial T}{\partial z} ( {x}_{s} , {z}_{s} , x , z ) )}^{2} - \frac{1}{{( V ( x , z ) )}^{2}} = 0 , \qquad EQ . 35$$

where xₛ (1017) and zₛ (1019) are coordinates of a source location Xₛ=(xₛ, zₛ) in the region of interest.

A trainable velocity network (1003) is configured to receive, as inputs, the lateral component x (1005) and depth component z (1007) of a point in the region of interest and return, as output, a velocity value N_{V}(α_{V}, x, z) (1013). The trainable velocity network (1003) is a first neural network that includes two fully connected layers, namely, a first fully connected layer (1008) and a second fully connected layer (1009). The first fully connected layer (1008) and second fully connected layer (1009) are connected together, as well as connected the input of the trainable velocity network (1003) and the output of the trainable velocity network (1003) by a first plurality of edges. The first plurality of edges is represented by directed lines, in a similar fashion to the edges (804) in FIG. 8. The first plurality of edges includes a first set of edges (1011). A trainable travel time network (1015) is configured to receive, as inputs, coordinates x, (1017) and z, (1019) of a source location Xₛ=(xₛ, zₛ) in the region of interest and the lateral component x (1005) and depth component z (1007) of a point in the region of interest. The trainable travel time network (1015) is configured to return, as output, a travel time value N_{T} (α_{T}, xₛ, zₛ, x, z) (1027). The trainable travel time network (1015) is a second neural network that includes two fully connected layers, namely, a third fully connected layer (1021) and a fourth fully connected layer (1023). The third fully connected layer (1021) and fourth fully connected layer (1023) are connected together, as well as connected to the input of the trainable travel time network (1015) and the output of the trainable travel time network (1015), by a second plurality of edges. The second plurality of edges is represented directed lines, in a similar fashion to the edges (804) in FIG. 8. The second plurality of edges includes a second set of edges (1025).

The travel times equation (1031) is a specific embodiment of the travel times equation (227) in FIG. 2. In this specific example, the travel tines equation (1031) is obtained by replacing, in EQ. 35, the travel time function T with the trainable travel tune network (1015) and the velocity function V with the trainable velocity network (1003):

$$f ( {α}_{V} , {α}_{T} , {x}_{z} , {z}_{s} , x , z ) := {( \frac{\partial {N}_{T}}{\partial x} ( {α}_{T} , {x}_{s} , {z}_{s} , x , z ) )}^{2} + {( \frac{\partial {N}_{T}}{\partial z} ( {α}_{T} , {x}_{s} , {z}_{s} , x , z ) )}^{2} - \frac{1}{{( {N}_{V} ( {α}_{V} , x , z ) )}^{2}} = 0. \qquad EQ . 36$$

A seismic dataset (1035) includes a plurality of seismic traces. Each seismic trace within the seismic dataset (1035) includes a seismic source location and a seismic receiver location. Denoting mₛ as a number of seismic source locations of the seismic traces in the seismic dataset (1035), the seismic source locations of the traces in the seismic dataset (1035) are denoted as Sᵢ=(x_{S,i}, z_{S,i}) for 1≤i≤mₛ. For each seismic source location Sᵢ, the number of seismic receiver locations in the seismic traces of the seismic dataset (1035) are denoted as mᵢ and the seismic receiver locations are denoted as R_{i,j}=(x_{R,i,j}, z_{R,i,j}), for 1≤j≤mᵢ. In this specific example, nₛ training source locations X_{s,i} are selected to be the same as the seismic source locations from the seismic dataset (1035), which means that nₛ=m, and X_{s,i}=Sᵢ=(x_{S,i}, z_{S,i}), for 1≤i≤nₛ. A number nₚ≥1 of training locations in the two-dimensional region of interest are denoted as Xⱼ=(xⱼ, zⱼ), for 1≤j≤nₚ. In this specific example, the training locations discretize the region of interest and form a regular grid.

The velocity parameters α_{V} and the travel time parameters α_{T} are initialized randomly. Then, the velocity parameters α_{V} and the travel time parameters α_{T} are updated as follows. Velocity values N_{V}(α_{V}, xⱼ, zⱼ) are computed for each training location (xⱼ, zⱼ) using the trainable velocity network (1003), for 1≤j≤nₚ. Travel times values N_{T}(α_{T}, x_{S,i}, z_{S,i}, xⱼ, zⱼ) are computed for each training source location (x_{S,i}, z_{S,i}) and each training location (xⱼ, zⱼ), for 1≤i≤mₛ, for 1≤j≤nₚ. Travel time derivatives

$$\frac{\partial {N}_{T}}{\partial x} ( {α}_{T} , {x}_{S , i} , {z}_{S , i} , {x}_{j} , {z}_{j} ) and \frac{\partial {N}_{T}}{\partial z} ( {α}_{T} , {x}_{S , i} , {z}_{S , i} , {x}_{j} , {z}_{j} )$$

are computed for each training source location (x_{S,i}, z_{S,i}) and each framing location (xⱼ, zⱼ), for 1≤i≤nₛ, for 1≤j≤nₚ. The travel tunes derivatives are computed using an automatic differentiation (AD) procedure (1029), known in the art and not described herein. An Eikonal mean squared error (MSE_{E}(α_{V}, α_{T})) (1039) is computed as a specific embodiment of the second term in the right-hand side of EQ. 29:

$${MSE}_{E} ( {α}_{V} , {α}_{T} ) = \frac{1}{{n}_{s} {n}_{p}} {\sum }_{i = 1}^{i = {n}_{s}} {\sum }_{j = 1}^{j = {n}_{p}} {\vert {( \frac{\partial {N}_{T}}{\partial x} ( {α}_{T} , {x}_{S , i} , {z}_{S , i} , {x}_{j} , {z}_{j} ) )}^{2} + {( \frac{\partial {N}_{T}}{\partial z} ( {α}_{T} , {x}_{S , i} , {z}_{S , i} , {x}_{j} , {z}_{j} ) )}^{2} - \frac{1}{{( {N}_{V} ( {α}_{V} , {x}_{j} , {z}_{j} ) )}^{2}} \vert}^{2} . \qquad EQ . 37$$

Velocity derivatives

$$\frac{\partial {N}_{V}}{\partial x} ( {α}_{V} , {x}_{j} , {z}_{j} ) ) and \frac{\partial {N}_{V}}{\partial z} ( {α}_{V} , {x}_{j} , {z}_{j} )$$

are computed at each training location (xⱼ, zⱼ) using the AD procedure (1029), for 1≤j≤nₚ. Travel times second derivatives

$$\frac{{\partial }^{2} {N}_{T}}{\partial {x}^{2}} ( {α}_{T} , {x}_{S , i} , {z}_{S , i} , {x}_{j} , {z}_{j} ) , \frac{{\partial }^{2} {N}_{T}}{\partial {z}^{2}} ( {α}_{T} , {x}_{S , i} , {z}_{S , i} , {x}_{j} , {z}_{j} ) and \frac{{\partial }^{2} {N}_{T}}{\partial x \partial z} ( {α}_{T} , {x}_{S , i} , {z}_{S , i} , {x}_{j} , {z}_{j} )$$

are computed at each training source location (x_{S,i}, z_{S,i}) and each training location (xⱼ, zⱼ) using the AD procedure (1029), for 1≤i≤nₛ, for 1≤j≤nₚ. Then, travel times equation derivatives (1032), defined as derivatives of the Eikonal equation EQ. 36, are computed as

$$\frac{\partial f}{\partial x} ( {α}_{V} , {α}_{T} , {x}_{S , i} , {z}_{S , i} , {x}_{j} , {z}_{j} ) and \frac{\partial f}{\partial z} ( {α}_{V} , {α}_{T} , {x}_{S , i} , {z}_{S , i} , {x}_{j} , {z}_{j} ) ,$$

at each training source location (x_{S,i}, Z_{S,i}) and each training location (xⱼ, zⱼ) for 1≤i≤nₛ, for 1≤j≤nₚ. A regularization mean squared error (MSEᵣ(α_{V}, α_{T})) (1041) is computed as a specific embodiment of the third term in the right-hand side of EQ. 29:

$${{MSE}_{r} ( {α}_{V} , {α}_{T} ) = \frac{1}{{n}_{s} {n}_{p}} {\sum }_{i = 1}^{i = {n}_{s}} {\sum }_{j = 1}^{j = {n}_{p}} {\vert ( \frac{\partial f}{\partial x} ( {α}_{V} , {α}_{T} , {x}_{S , i} , {z}_{S , i} , {x}_{j} , {z}_{j} ) \vert}^{2} + {( \frac{\partial f}{\partial z} ( {α}_{V} , {α}_{T} , {x}_{S , i} , {z}_{S , i} , {x}_{j} , {z}_{j} ) )}^{2} - \frac{1}{{( {N}_{V} ( {α}_{V} , {x}_{j} , {z}_{j} ) )}^{2}} \vert}^{2} . \qquad EQ . 38$$

An interface condition (1033) states that the shortest travel tines from a seismic source location to itself is zero, in the same fashion as EQ. 17. Travel times from seismic source locations to themselves are computed as N_{T}(α_{T}, x_{S,i}, z_{S,i}, z_{S,i}, z_{S,i}) for each training source location (x_{S,i}, z_{S,i}) for 1≤i≤nₛ. An interface mean squared error (MSEₗ(α_{T})) (1045) is computed as a specific embodiment of the fourth term in the right-hand side of EQ. 29:

$${MSE}_{I} ( {α}_{T} ) = \frac{1}{{n}_{s}} {\sum }_{i = 1}^{i = {n}_{s}} {\vert {N}_{T} ( {α}_{T} , {x}_{S , i} , {z}_{S , i} , {x}_{S , i} , {z}_{S , i} ) \vert}^{2} . \qquad EQ . 39$$

In this specific example, the whole seismic dataset (1035) is used as a training dataset. For each seismic trace in the seismic dataset (1035), an observed travel time T_{obs,i,j}=T_{obs}(Sᵢ, R_{i,j}) is determined in the same way as the observed travel times (211) in FIG. 2, where Sᵢ is the seismic source location of the seismic trace and R_{i,j} is the seismic receiver location of the seismic trace. The values T_{obs,i,j} form the observed travel times (1036) in FIG. 10. For each seismic source location (x_{S,i}, z_{S,i}), for 1≤i≤nₛ, computed travel times N_{T}(α_{T}, x_{S,i}, z_{S,i}, xⱼ, zⱼ) are computed for each seismic receiver locations (x_{R,i,j}, z_{R,i,j}), for 1≤j≤mᵢ. A travel time mismatch (1037) between an observed travel time T_{obs}(xₛ, zₛ, x_{R}, z_{R}) and a computed travel time N_{T}(α_{T}, xₛ, zₛ, x_{R}, z_{R}), for a seismic source location (xₛ, zₛ) and a seismic receiver location (xₛ, zₛ), is defined as N_{T}(α_{T}, xₛ, zₛ, x_{R}, z_{R})−T_{obs}(xₛ, zₛ, x_{R}, z_{R}). A mismatch mean squared error (MSEₘ(α_{T})) (1047) is computed as a specific embodiment of the first term in the right-had side of EQ. 29:

$${MSE}_{m} ( {α}_{T} ) = \frac{1}{{\sum }_{j = 1}^{i = {n}_{s}} {m}_{i}} {\sum }_{i = 1}^{i = {m}_{s}} {\sum }_{j = 1}^{j = {m}_{i}} {\vert {T}_{obs , i , j} - {N}_{T} ( {α}_{T} , {x}_{S , i} , {z}_{S , i} , {x}_{j} , {z}_{j} ) \vert}^{2} . \qquad EQ . 40$$

A cost L(α_{T}, xₛ) (1049) is computed as a sum of the tens MSE_{E}(α_{V}, α_{T}), MSEᵣ(α_{V}, α_{T}), MSEₗ(α_{T}) and MSEₘ(α_{T}) from EQs. 37-40. The cost L(α_{T}, xₛ) (1049) is a specific embodiment of the term L(α_{V}, α_{T}) in EQ. 29:

$$EQ . 41$$

$$L ( {α}_{T} , {x}_{S} ) = {MSE}_{E} ( {α}_{V} , {α}_{T} ) + {MSE}_{r} ( {α}_{V} , {α}_{T} ) + {MSE}_{l} ( {α}_{T} ) + {MSE}_{m} ( {α}_{T} ) .$$

A cost function L:(α_{V}, α_{T})→L(α_{V}, α_{T}) is a specific embodiment of the cost function in FIGS. 2, 4, 6 and 7. A gradient ∇_{α}L(α_{V}, α_{T}) is computed using a backpropagation (1051) The gradient ∇_{α}L(α_{V}, α_{T}) can be written as a set of two vectors, namely, ∇_{α}L(α_{V}, α_{T}) and ∇_{α}L(α_{V}, α_{T}). The vector ∇_{α}L(α_{V}, α_{T}) is composed of the partial derivatives of the cost function L with respect to the parameters within the velocity parameters α_{V}. The vector ∇_{α}L(α_{V}, α_{T}) is composed of the partial derivatives of the cost function L with respect to the parameters within the travel time parameters α_{T}. The velocity parameters α_{V} and the travel time parameters α_{T}, are updated by a gradient descent step (1052). The gradient descent step includes updating the travel time parameters using an α_{T} update (1053) and updating the velocity parameters using an α_{V} update (1055). The α_{T} update (1053) updates the travel time parameters as α_{T}−δ∇_{α}L(α_{V}, α_{T}), where δ is a positive learning rate. The α_{V} update (1055) updates the velocity parameters as α_{V}−δ∇_{α}L(α_{V}, α_{T}).

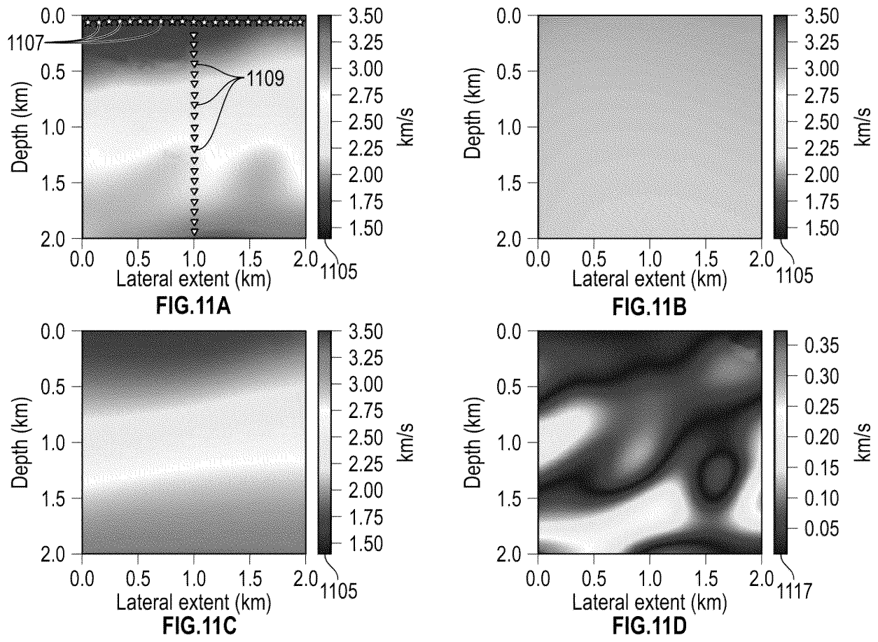

FIGS. 11A, 11B. 11C and 11D depicts an example result of using some of the systems (200), (300), (400) and the methods (600) and (700) for training the trainable velocity network and the trainable travel time network, and obtaining an isotropic velocity model for a region of interest. The region of interest is two-dimensional (D=2). FIG. 11A depicts an original velocity model in the region of interest. The original velocity model is isotropic. The values of the original velocity model can be inferred with a first colormap (1105). The velocity model depicted in FIG. 11A is used in a simulator, such as the simulator (207) in FIG. 2, to create a synthetic seismic dataset of seismic traces. The seismic source locations (1107) of the seismic traces of the synthetic seismic dataset are depicted by white stars. The seismic receiver locations (1109) of the seismic traces of the synthetic seismic dataset are depicted by black triangles. In some embodiments, the synthetic seismic dataset represents a vertical seismic profiling acquisition. The original velocity model is sampled on 20 m×20 m regular grid of prediction locations, denoted as

$${W}_{j}^{V} ,$$

for

$$1 \leq j \leq {n}_{w}^{V} .$$

The trainable velocity network N_{V} is a first neural network that includes 10 fully connected layers, with 10 neurons per layer. The trainable travel time network N_{T} is a second neural network that includes 10 fully connected layers, with 20 neurons per layer. The velocity parameters are initialized randomly as

$${α}_{V}^{0} .$$

The travel time parameters are initialized randomly as

$${α}_{T}^{0} .$$

An initial velocity model is computed by inputting, to the trainable velocity network with the initial velocity parameters, each prediction location within the regular grid, and recording the outputs. The values of the initial velocity model are defined as

$${V}_{0 , j} = {N}_{V} ( {α}_{V}^{0} , {W}_{j}^{V} ) ,$$

for

$$1 \leq j \leq {n}_{w}^{V} .$$

The initial velocity model is displayed m FIG. 11B The trainable velocity network and trainable travel time network are trained using the method (600). In this specific example, the whole seismic dataset is used as a training dataset. The training source locations are the same as the seismic source locations (1107) in FIG. 11A. The number of training locations are selected as one half of the number of prediction locations. The trainable velocity network and trainable travel time network are trained using a cost function similar to the cost function L in FIG. 10 and a gradient descent method similar to the one used in the description of FIG. 10. The gradient descent method includes the backpropagation (1051) and the gradient descent step (1052). The gradient descent method is iterated for 250 iterations. Trained velocity parameters \hat{α}_{V} are the velocity parameters at the 250^{th} iteration, denoted as

$${α}_{V}^{250} .$$

Trained travel times parameters \hat{α}_{T} are the travel time parameters at the 250^{th} iteration, denoted as

$${α}_{T}^{250} .$$

A trained velocity network is form using

$${α}_{V}^{250}$$

as velocity parameters in the trainable velocity network. A trained travel time network is form using

$${α}_{T}^{250}$$

as travel time parameters in the trainable travel time network.

A final velocity model is created in a similar fashion to the velocity model (309) in FIG. 3. The final velocity model is formed by inputting, one by one, each prediction location

$${W}_{j}^{V}$$

to the trained velocity network and recording the output, for

$$1 \leq j \leq {n}_{w}^{V} .$$

That is, the final velocity model includes velocity values

$${V}_{250 , j} = {N}_{V} ( {α}_{V}^{250} , {W}_{j}^{V} ) ,$$

for

$$1 \leq j \leq {n}_{w}^{V} .$$

The final velocity model is displayed in FIG. 11C. A difference between the final velocity model and the original velocity model is displayed in FIG. 11D. The values of the difference in FIG. 11D can be inferred from a second colormap (1117). In some embodiments, an interpretation of FIG. 11D is that the difference between the final velocity model and the original velocity model is small, meaning that the final velocity model computed by the trained velocity network is substantially similar to the original velocity model in FIG. 11A.

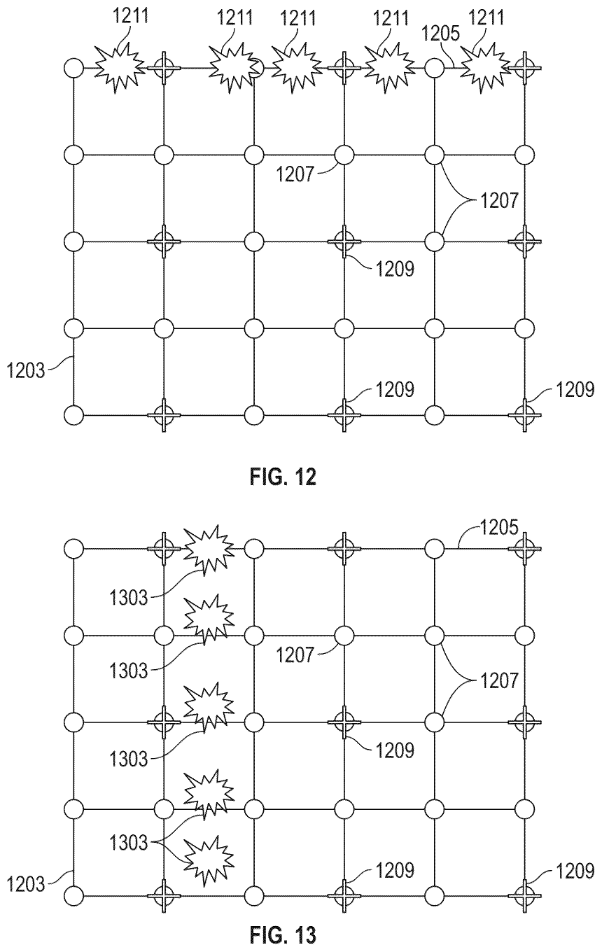

FIG. 12 depicts example training source locations and training locations for training the trainable velocity network (213) and trainable travel time network (219). FIG. 12 further depicts example prediction locations for computing the velocity model (309) in FIG. 3. In FIG. 12, a region of interest (1203) is two-dimensional. The region of interest (1203) includes a surface (1205), which is a portion of the surface of the Earth Prediction locations (1207), depicted as grey dots in FIG. 12, form a first regular grid that discretize the region of interest (1203). Training locations (1209), depicted as crosses, form a second regular grid discretizing the region of interest (1203). The second regular grid, of training locations (1209), is coarser than the first grid of prediction locations (1207). In one or more embodiments, the number of training locations is selected based on a power of the computer used to perform the computations, such as the computer (433) in FIG. 4. It is noted that the first grid of prediction locations needs not be regular. It is also noted that the second grid of training locations does not need to be regular or discretize the region of interest (1203). Both the first grid and the second grid are regular and discretize the region of interest (1203) in this specific example, for illustration purposes. Further, the training locations (1209) constitute a subset of the prediction locations (1207), in this specific example. In other embodiments, the training locations (1209) need not constitute a subset of the prediction locations (1207). Training source locations (1211) are located, in this specific example, on the surface (1205) and depicted as grey stars.

FIG. 13 depicts example training source locations, training locations for training the trainable velocity network (213) and trainable travel time network (219). FIG. 12 depicts example prediction locations for computing the velocity model (309) in FIG. 3. For concision, a foll description of components and/or elements depicted in FIG. 4 is not provided anew for those components and/or elements that have been previously described with reference to the preceding figures. FIG. 13 includes the region of interest (1203), that includes the surface (1205). FIG. 13 further includes the prediction locations (1207) and training locations (1209). Training source locations (1303) are located, in this specific example, on a vertical line in the subsurface, and depicted as grey stars.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
obtaining, from a data acquisition system, a seismic dataset of seismic traces pertaining to a region of interest, wherein each seismic trace within the seismic dataset comprises a seismic source location and a seismic receiver location;
determining, for each seismic trace within the seismic dataset, an observed travel time between the seismic source location of the seismic trace and the seismic receiver location of the seismic trace;
obtaining a trainable velocity network configured to receive, as input, a prediction location in the region of interest and return, as output, a velocity value, wherein the trainable velocity network depends on one or more velocity parameters;
obtaining a trainable travel time network configured to receive, as input, a source location and a prediction location and return, as output, a travel time value, wherein the trainable travel time network depends on one or more travel time parameters;
training the trainable travel time network and the trainable velocity network, wherein the training comprises:
obtaining a travel times equation modeling a travel time of a seismic wave in the region of interest according to a seismic velocity, the travel times equation based on the trainable travel time network and the trainable velocity network;
constructing a cost function configured to receive, as inputs, the one or more travel times parameters and the one or more velocity parameters and return, as output, a cost based on:
the travel times equation;
a derivative of the travel times equation, and
a travel time mismatch between:
a first observed travel time between a first seismic source location and a first seismic receiver location, and
a first travel time value output by the trainable travel time network upon receiving, as inputs, the first seismic source location and the first seismic receiver location, and
computing, with an optimizer, one or more trained travel times parameters and one or more trained velocity parameters, wherein the optimizer is configured to seek to minimize the cost function, and
building an image of a velocity model using the trainable velocity network and the one or more trained velocity parameters.

2. The method of claim 1, wherein:
the trainable velocity network comprises a first neural network, and
the trainable travel time network comprises a second neural network.

3. The method of claim 1, wherein the travel times equation is further based on an Eikonal equation.

4. The method of claim 1, wherein the cost function is further based on an interface condition associated with the travel times equation.

5. A method, comprising:
obtaining a first plurality of prediction locations discretizing a region of interest;
obtaining a trained velocity network configured to receive, as input, a prediction location in the region of interest and return, as output, a velocity value at the prediction location, the trained velocity network based on one or more trained velocity parameters, wherein the one or more trained velocity parameters are determined by using an optimizer that seeks to minimize a cost fiction based on:
a travel times equation modeling a travel time of a seismic wave in the region of interest according to a seismic velocity, the travel times equation based on a trainable velocity network and a trainable travel time network, wherein:
the trainable velocity network is based on one or more velocity parameters;
the one or more velocity parameters are received by the cost function as inputs, and
the trained velocity network is obtained upon replacing, in the trainable velocity network, the one or more velocity parameters with the one or more trained velocity parameters, and
a derivative of the travel times equation, and
determining a velocity model for the region of interest, the velocity model comprising one velocity value for each prediction location within the first plurality of prediction locations, wherein, for each prediction location, the velocity value is determined by inputting the prediction location to the trained velocity network.

6. The method of claim 5, wherein:
the trainable velocity network comprises a first neural network, and
the trainable travel time network comprises a second neural network.

7. The method of claim 5, wherein the travel times equation is based on an Eikonal equation.

8. The method of claim 5, further comprising:
obtaining, from a seismic acquisition system, a seismic dataset of seismic traces pertaining to a region of interest,
wherein each seismic trace within the seismic dataset comprises a seismic source location and a seismic receiver location, and
wherein, for each seismic trace, a receiver at the seismic receiver location of the seismic trace detects ground motion of a seismic wave radiating from the seismic source location of the seismic trace, and
forming a seismic image of the region of interest based on the seismic dataset and the velocity model.

9. The method of claim 8, further comprising:
obtaining a trained travel time network configured to receive, as input, a source location in the region of interest and a prediction location in the region of interest and return, as output, a travel time value of a seismic wave between the source location and the prediction location, the trained travel time network based on one or more trained travel time parameters, wherein:
the one or more trained travel time parameters are determined using the optimizer;
the trainable travel time network is based on one or more travel time parameters;
the cost function further receives, as inputs, the one or more travel time parameters, and
the trained travel time network is obtained upon replacing, in the trainable travel time network, the one or more travel time parameters with the one or more trained travel time parameters;
obtaining, a plurality of source locations in the region of interest;
obtaining a second plurality of prediction locations discretizing the region of interest, and
determining a travel time cube for the region of interest, the travel time cube comprising one travel time value for each pair composed of a source location within the plurality of source locations and prediction location within the second plurality of prediction locations wherein, for each a source location and each prediction location, the travel time value is determined by inputting the pair composed of the source location and the prediction location to the trained travel time network,
wherein forming the seismic image is based on the travel time cube.

10. The method of claim 8, further comprising:
identifying, using a seismic interpretation workstation, a drilling target based, at least in part, on the seismic mage, and
planning, using a well planning system, a wellbore trajectory guided by the drilling target.

11. The method of claim 10, further comprising drilling, using a drilling system, a wellbore guided by the wellbore trajectory.

12. A system, comprising:
a seismic acquisition system configured to acquire a seismic dataset of seismic traces pertaining to a region of interest,
wherein each seismic trace within the seismic dataset comprising a seismic source location and a seismic receiver location, and
wherein, for each seismic trace, a receiver at the seismic receiver location of the seismic trace detects ground motion of a seismic wave radiating from the seismic source location of the seismic trace, and
a seismic processing system, configured to:
receive the seismic dataset from the seismic acquisition system;
determine, for each seismic trace within the seismic dataset, an observed travel time between the seismic source location of the seismic trace and the seismic receiver location of the seismic trace;
form a trainable velocity network configured to receive, as input, a prediction location in the region of interest and return, as output, a velocity value, wherein the trainable velocity network depends on one or more velocity parameters;
forma a trainable travel time network configured to receive, as input, a source location and a prediction location and return, as output, a travel time value, wherein the trainable travel time network depends on one or more travel time parameters, and
train the trainable travel time network and the trainable velocity network, wherein training the trainable travel time network and the trainable velocity network comprises:
obtaining a travel times equation modeling a travel time of a seismic wave in the region of interest according to a seismic velocity, the travel times equation based on the trainable travel time network and the trainable velocity network;
constructing a cost function configured to receive, as inputs, the one or more travel times parameters and the one or more velocity parameters and return, as output, a cost based on:
the travel times equation;
a derivative of the travel times equation, and
a travel time mismatch between:
a first observed travel time between a first seismic source location and a first seismic receiver location, and
a first travel time value output by the trainable travel time network upon receiving, as inputs, the first seismic source location and the first seismic receiver location, and
computing, with an optimizer, one or more trained travel times parameters and one or more trained velocity parameters, wherein the optimizer is configured to seek to minimize the cost function.

13. The system of claim 12, wherein:
the trainable velocity network comprises a first neural network, and
the trainable travel time network comprises a second neural network.

14. The system of claim 12, wherein the travel times equation is based on an Eikonal equation.

15. The system of claim 12, wherein the cost function is further based on an interface condition associated with the travel times equation.

16. The system of claim 12, wherein the seismic processing system is further configured to:
form a trained velocity network by replacing, in the trainable velocity network, the one or more velocity parameters with the one or more trained velocity parameters, and
determine a velocity model for the region of interest, the velocity model comprising one velocity value for each prediction location within a first plurality of prediction locations, wherein, for each prediction location within a first plurality of prediction locations, the velocity value is determined by inputting the prediction location to the trained velocity network.

17. The system of claim 16, wherein the seismic processing system is further configured to form a seismic image of the region of interest based on the seismic dataset and the velocity model.

18. The system of claim 17, wherein:
the seismic processing system is further configured to:
form a trained travel time network by replacing, in the trainable travel time network, the one or more travel time parameters with the one or more trained travel time parameters, and
determine a travel time cube for the region of interest, the travel tune cube comprising one travel time value for each pair composed of a source location within a plurality of source locations and prediction location within a second plurality of prediction locations wherein, for each a source location within a plurality of source locations and each prediction location within the second plurality of prediction locations, the travel time value is determined by inputting a pair composed of the source location and the prediction location to the trained travel time network, and
forming the seismic image is based on the travel time cube.

19. The system of claim 17, further comprising:
a seismic interpretation workstation, configured to:
receive the seismic image from the seismic processing system, and
identify a drilling target based, at least in part, on the seismic image, and
a well planning system, configured to:
receive the drilling target from the seismic interpretation workstation, and
plan a wellbore trajectory guided by the drilling target.

20. The system of claim 19, further comprising a chilling system, configured to:
receive the wellbore trajectory from the well planning system, and
drill a wellbore guided by the wellbore trajectory.
